(19) United States
(12) Patent Application Publication
(10) Pub. No.: US 2026/0253538 A1
(43) Pub. Date: Aug. 27, 2026

(54) DRIVING CIRCUIT, DRIVING METHOD, PIXEL CIRCUIT, DISPLAY PANEL AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Ziyang Yu, Beijing (CN); Haijun Qiu, Beijing (CN); Ming Hu, Beijing (CN); Zhiliang Jiang, Beijing (CN); Qingqing Yan, Beijing (CN); Pan Zhao, Beijing (CN); Qing He, Beijing (CN); Dan Cao, Beijing (CN)

(73) Assignees: CHENGDU BOE OPTOELECTRONICS TECHNOLOGY CO., LTD., Chengdu, Sichuan (CN); BOE TECHNOLOGY GROUP CO., LTD., Beijing (CN)

(21) Appl. No.: 18/994,140

(22) PCT Filed: May 23, 2024
(86) PCT No.: PCT/CN2024/094815

§ 371 Date: Jan. 14, 2025

(30) Foreign Application Priority Data
Jun. 16, 2023 (CN) 202310717043.0

(51) Int. Cl. G09G 3/3233; G09G 3/3266

(52) U.S. Cl. CPC G09G 3/3233; G09G 3/3266; G09G 2300/0819; G09G 2300/0842; G09G 2310/08; G09G 2320/045; G09G 2330/021

(57) ABSTRACT

A driving circuit, a driving method, a pixel circuit, a display panel and a display device are provided. The driving circuit includes a first switching circuit and a scanning signal generation circuit. The first switching circuit writes a data signal provided by a data output end into the scanning signal generation circuit under the control of a first gating control signal. The scanning signal generation circuit generates a scanning signal in accordance with the data signal, and outputs the scanning signal through a scanning signal output end.

### CROSS-REFERENCE TO RELATED APPLICATION

This application claims a priority of the Chinese patent application No. 202310717043.0 filed on Jun. 16, 2023, which is incorporated herein by reference in its entirety.

### TECHNICAL FIELD

The present disclosure relates to the field of display technology, in particular to a driving circuit, a driving method, a pixel circuit, a display panel and a display device.

### BACKGROUND

An Organic Light-emitting Diode (OLED) display technology has such advantages as high contrast, rapid response and low power consumption. In order to further reduce the power consumption, a Low Temperature Polycrystalline Oxide (LTPO) display technology implemented using Low Temperature Polysilicon (LTPS)+Indium Gallium Zinc Oxide (IGZO) is used to achieve the display at a low frame frequency, and reduce the driving power consumption through reducing the repeated refreshing of a static image. However, in a case of updating an image on an existing OLED display, all pixel voltages still need to be initialized and written within one frame. In some special images, a vast majority of the pixel voltages for an entire screen do not need to be updated, i.e., original display brightness may be maintained through an LTPO Thin Film Transistor (TFT) with a low leakage current, so the repeated refreshing and writing of these pixel voltages leads to a waste of the power consumption of data lines.

### SUMMARY

In one aspect, the present disclosure provides in some embodiments a driving circuit, including a first switching circuit and a scanning signal generation circuit. The first switching circuit is electrically coupled to a first gating control line, a data output end of a source driver and the scanning signal generation circuit, and configured to control to write a data signal provided by the data output end into the scanning signal generation circuit under the control of a first gating control signal provided by the first gating control line. The scanning signal generation circuit is configured to generate a scanning signal in accordance with the data signal, and output the scanning signal through a scanning signal output end.

In a possible embodiment of the present disclosure, the driving circuit further includes a second switching circuit, the second switching circuit is electrically coupled to a second gating control line, the data output end and a data line included in a display panel, and configured to control the data output end to be electrically coupled to, or electrically decoupled from, the data line under the control of a second gating control signal provided by the second gating control line. The first gating control line and the second gating control line are a same gating control line, or the first gating control line is different from the second gating control line.

In a possible embodiment of the present disclosure, the first switching circuit includes a first transistor and a first capacitor, and the first switching circuit provides the data signal to the scanning signal generation circuit through a control node. A gate electrode of the first transistor is electrically coupled to the first gating control line, a first electrode of the first transistor is electrically coupled to the data output end, and a second electrode of the first transistor is electrically coupled to the control node. A first end of the first capacitor is electrically coupled to the control node, and a second end of the first capacitor is electrically coupled to a direct-current voltage end.

In a possible embodiment of the present disclosure, the second switching circuit includes a second transistor, a gate electrode of the second transistor is electrically coupled to the second gating control line, a first electrode of the second transistor is electrically coupled to the data output end, and a second electrode of the second transistor is electrically coupled to the data line.

In a possible embodiment of the present disclosure, the scanning signal generation circuit includes an output control circuit and an output circuit, and the first switching circuit provides the data signal to the scanning signal generation circuit through a control node. The output control circuit is electrically coupled to the control node, a first voltage end, a second voltage end, an output control end and a scanning output end, and configured to control the output control end to be electrically coupled to, or electrically decoupled from, the first voltage end under the control of a potential at the control node, and control the output control end to be electrically coupled to, or electrically decoupled from, the second voltage end under the control of a signal provided by the scanning output end. The output circuit is electrically coupled to a control end, the scanning output end, the output control end, the first voltage end and the second voltage end, and configured to control the scanning output end to be electrically coupled to, or electrically decoupled from, the first voltage end under the control of a control signal provided by the control end, and control the scanning output end to be electrically coupled to, or electrically decoupled from, the second voltage end under the control of a potential at the output control end.

In a possible embodiment of the present disclosure, the scanning output end is the scanning signal output end; or the scanning signal generation circuit further includes a phase inverting circuit, an input end of the phase inverting circuit is electrically coupled to the scanning output end, an output end of the phase inverting circuit is electrically coupled to the scanning signal output end, and the phase inverting circuit is configured to invert a phase of a voltage signal received by the input end of the phase inverting circuit to obtain a phase-inverted voltage signal, and output the phase-inverted voltage signal through the output end of the phase inverting circuit.

In a possible embodiment of the present disclosure, the output control circuit includes a third transistor and a fourth transistor; a gate electrode of the third transistor is electrically coupled to the control node, a first electrode of the third transistor is electrically coupled to the first voltage end, and a second electrode of the third transistor is electrically coupled to the output control end; a gate electrode of the fourth transistor is electrically coupled to the scanning output end, a first electrode of the fourth transistor is electrically coupled to the output control end, and a second electrode of the fourth transistor is electrically coupled to the second voltage end; the output circuit includes a fifth transistor, a sixth transistor and a second capacitor; a gate electrode of the fifth transistor is electrically coupled to the control end, a first electrode of the fifth transistor is electrically coupled to the first voltage end, and a second electrode of the fifth transistor is electrically coupled to the scanning output end; a gate electrode of the sixth transistor is electrically coupled to the output control end, a first electrode of the sixth transistor is electrically coupled to the scanning output end, and a second electrode of the sixth transistor is electrically coupled to the second voltage end; and a first end of the second capacitor is electrically coupled to the control end, and a second end of the second capacitor is electrically coupled to the second voltage end.

In another aspect, the present disclosure provides in some embodiments a driving method for the above-mentioned driving circuit, including, within at least a part of a blank time period between two display frames: controlling, by a first switching circuit, to write a data signal provided by a data output end of a source driver into a scanning signal generation circuit under the control of a first gating control signal; and generating, by the scanning signal generation circuit, a scanning signal in accordance with the data signal, and outputting the scanning signal to a corresponding scanning line in a display panel through a scanning signal output end.

In a possible embodiment of the present disclosure, the driving circuit further includes a second switching circuit, and the driving method further includes, within a data write-in time period in one display frame, controlling, by the second switching circuit, the data output end of the source driver to be electrically coupled to a corresponding data line in the display panel under the control of a second gating control signal.

In yet another aspect, the present disclosure provides in some embodiments a pixel circuit, including a light-emitting element, a light-emission driving circuit and a control circuit; the light-emission driving circuit is electrically coupled to a first node and a first electrode of the light-emitting element and configured to generate a driving current for driving the light-emitting element under the control of a potential at the first node, and a second electrode of the light-emitting element is electrically coupled to a third voltage end; and the control circuit is electrically coupled to a first gate line, a scanning line, the first node and the first electrode of the light-emitting element, and configured to control the first node to be electrically coupled to, or electrically decoupled from, the first electrode of the light-emitting element under the control of a first gate driving signal provided by the first gate line and a scanning signal provided by the scanning line.

In a possible embodiment of the present disclosure, the control circuit includes a first control circuit and a second control circuit, a first end of the light-emission driving circuit is electrically coupled to a second node, and a second end of the light-emission driving circuit is electrically coupled to a third node and the first electrode of the light-emitting element; the first control circuit is electrically coupled to the first gate line, the first node and an intermediate node, and configured to control the first node to be electrically coupled to, or electrically decoupled from, the intermediate node under the control of the first gate driving signal provided by the first gate line; and the second control circuit is electrically coupled to the scanning line, the intermediate node and the third node, and configured to control the intermediate node to be electrically coupled to, or electrically decoupled from, the third node under the control of the scanning signal provided by the scanning line.

In a possible embodiment of the present disclosure, the control circuit includes a first control circuit and a second control circuit, a first end of the light-emission driving circuit is electrically coupled to a second node, and a second end of the light-emission driving circuit is electrically coupled to a third node and the first electrode of the light-emitting element; the first control circuit is electrically coupled to the first gate line, the third node and an intermediate node, and configured to control the third node to be electrically coupled to, or electrically decoupled from, the intermediate node under the control of the first gate driving signal provided by the first gate line; and the second control circuit is electrically coupled to the scanning line, the intermediate node and the first node, and configured to control the intermediate node to be electrically coupled to, or electrically decoupled from, the first node under the control of the scanning signal provided by the scanning line.

In a possible embodiment of the present disclosure, the pixel circuit further includes a first initialization circuit, a first end of the light-emission driving circuit is electrically coupled to a second node, and a second end of the light-emission driving circuit is electrically coupled to a third node and the first electrode of the light-emitting element; and the first initialization circuit is electrically coupled to a first initial control end, a first initial voltage end and the second node, and configured to write a first initial voltage provided by the first initial voltage end into the second node under the control of a first initial control signal provided by the first initial control end.

In a possible embodiment of the present disclosure, the pixel circuit further includes a second initialization circuit, a first end of the light-emission driving circuit is electrically coupled to a second node, and a second end of the light-emission driving circuit is electrically coupled to a third node and the first electrode of the light-emitting element; and the second initialization circuit is electrically coupled to a second initial control end, a second initial voltage end and the third node, and configured to write a second initial voltage provided by the second initial voltage end into the third node under the control of a second initial control signal provided by the second initial control end.

In a possible embodiment of the present disclosure, the pixel circuit further includes a data write-in circuit, a first light-emission control circuit, a second light-emission control circuit and an energy storage circuit; a first end of the light-emission driving circuit is electrically coupled to a second node, and a second end of the light-emission driving circuit is electrically coupled to a third node and the first electrode of the light-emitting element; the data write-in circuit is electrically coupled to a second gate line, a data line and the second node, and configured to write a data voltage provided by the data line into the second node under the control of a second gate driving signal provided by the second gate line; the first light-emission control circuit is electrically coupled to a light-emission control line, a power source voltage end and the second node, and configured to control the power source voltage end to be electrically coupled to, or electrically decoupled from, the second node under the control of a light-emission control signal provided by the light-emission control line; the second light-emission control circuit is electrically coupled to the light-emission control line, the third node and the first electrode of the light-emitting element, and configured to control the third node to be electrically coupled to the first electrode of the light-emitting element under the control of the light-emission control signal; and the energy storage circuit is electrically coupled to the first node, and configured to store electric energy.

In a possible embodiment of the present disclosure, the pixel circuit further includes a third initialization circuit, the third initialization circuit is electrically coupled to a first initial control end, a third initial control end and the first electrode of the light-emitting element, and configured to write a third initial voltage provided by the third initial voltage end into the first electrode of the light-emitting element under the control of a first initial control signal provided by the first initial control end.

In a possible embodiment of the present disclosure, the first control circuit includes a first control transistor, and the second control circuit includes a second control transistor; a gate electrode of the first control transistor is electrically coupled to the first gate line, a first electrode of the first control transistor is electrically coupled to the first node, and a second electrode of the first control transistor is electrically coupled to the intermediate node; and a gate electrode of the second control transistor is electrically coupled to the scanning line, a first electrode of the second control transistor is electrically coupled to the intermediate node, and a second electrode of the second control transistor is electrically coupled to the third node.

In a possible embodiment of the present disclosure, the first control circuit includes a first control transistor, and a second control circuit includes a second control transistor; a gate electrode of the first control transistor is electrically coupled to the first gate line, a first electrode of the first control transistor is electrically coupled to the intermediate node, and a second electrode of the first control transistor is electrically coupled to the third node; and a gate electrode of the second control transistor is electrically coupled to the scanning line, a first electrode of the second control transistor is electrically coupled to the first node, and a second electrode of the second control transistor is electrically coupled to the intermediate node.

In a possible embodiment of the present disclosure, the first initialization circuit includes a first initialization transistor, a gate electrode of the first initialization transistor is electrically coupled to the first initial control end, a first electrode of the first initialization transistor is electrically coupled to the first initial voltage end, and a second electrode of the first initialization transistor is electrically coupled to the second node.

In a possible embodiment of the present disclosure, the second initialization circuit includes a second initialization transistor, a gate electrode of the second initialization transistor is electrically coupled to the second initial control end, a first electrode of the second initialization transistor is electrically coupled to the second initial voltage end, and a second electrode of the second initialization transistor is electrically coupled to the third node.

In a possible embodiment of the present disclosure, the data write-in circuit includes a write-in transistor, the first light-emission control circuit includes a first light-emission control transistor, the second light-emission control circuit includes a second light-emission control transistor, the light-emission driving circuit includes a driving transistor, and the energy storage circuit includes a storage capacitor; a gate electrode of the write-in transistor is electrically coupled to the second gate line, a first electrode of the write-in transistor is electrically coupled to the data line, and a second electrode of the write-in transistor is electrically coupled to the second node; a gate electrode of the first light-emission control transistor is electrically coupled to the light-emission control line, a first electrode of the first light-emission control transistor is electrically coupled to the power source voltage end, and a second electrode of the first light-emission control transistor is electrically coupled to the second node; a gate electrode of the second light-emission control transistor is electrically coupled to the light-emission control line, a first electrode of the second light-emission control transistor is electrically coupled to the third node, and a second electrode of the second light-emission control transistor is electrically coupled to the first electrode of the light-emitting element; a gate electrode of the driving transistor is electrically coupled to the first node, a first electrode of the driving transistor is electrically coupled to the second node, and a second electrode of the driving transistor is electrically coupled to the third node; and a first end of the storage capacitor is electrically coupled to the first node, and a second end of the storage capacitor is electrically coupled to the power source voltage end.

In a possible embodiment of the present disclosure, the third initialization circuit includes a third initialization transistor, a gate electrode of the third initialization transistor is electrically coupled to the first initial control end, a first electrode of the third initialization transistor is electrically coupled to the third initial voltage end, and a second electrode of the third initialization transistor is electrically coupled to the first electrode of the light-emitting element.

In still yet another aspect, the present disclosure provides in some embodiments a pixel driving method for the above-mentioned pixel circuit, including: generating, by a light-emission driving circuit, a driving current for driving a light-emitting element under the control of a potential at a first node; and controlling, by a control circuit, the first node to be electrically coupled to, or electrically decoupled from, a first electrode of a light-emitting element under the control of a first gate driving signal and a scanning signal.

In a possible embodiment of the present disclosure, the pixel circuit includes a first initialization circuit, a first end of the light-emission driving circuit is electrically coupled to a second node, a second end of the light-emission driving circuit is electrically coupled to a third node and the first electrode of the light-emitting element, and a display period includes a first initialization time period and a second initialization time period arranged one after another. The pixel driving method includes: within the first initialization time period, controlling, by the control circuit, the first node to be electrically coupled to the third node under the control of the first gate driving signal and the scanning signal, writing, by the first initialization circuit, a first initial voltage into the second node under the control of a first initial control signal, and controlling, by the light-emission driving circuit, the second node to be electrically coupled to the third node under the control of a potential at the first node; and within a second initialization time period, controlling, by the control circuit, the first node to be electrically decoupled from the third node under the control of the first gate driving signal and the scanning signal, writing, by the first initialization circuit, the first initial voltage into the second node under the control of the first initial control signal, and controlling, by the light-emission driving circuit, the second node to be electrically coupled to the third node under the control of the potential at the first node.

In still yet another aspect, the present disclosure provides in some embodiments a display panel, including a source driver and the above-mentioned driving circuit. The source driver includes a data output end.

In a possible embodiment of the present disclosure, the display panel includes a plurality of scanning lines, and a scanning signal output end in a scanning signal generation circuit of the driving circuit is electrically coupled to the scanning line.

In a possible embodiment of the present disclosure, the display panel includes a plurality of data lines; the data output end is directly electrically coupled to the data line; or the driving circuit includes a second switching circuit, and the second switching circuit is configured to control the data output end to be electrically coupled to, or electrically decoupled from, the data line under the control of a second gating control signal.

In a possible embodiment of the present disclosure, the source driver is arranged at a first side of the display panel, and the driving circuit is arranged at the first side of the display panel; or the source driver is arranged at the first side of the display panel, the driving circuit is arranged at a second side of the display panel, and the first side is opposite to the second side.

In a possible embodiment of the present disclosure, the display panel further includes the above-mentioned pixel circuit.

In still yet another aspect, the present disclosure further provides in some embodiments a display device, including the above-mentioned display panel.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a block diagram of a driving circuit according to at least one embodiment of the present disclosure;

FIG. 2 is a circuit diagram of the driving circuit according to at least one embodiment of the present disclosure;

FIG. 3 is a circuit diagram of the driving circuit according to at least one embodiment of the present disclosure;

FIG. 4 is a circuit diagram of the driving circuit according to at least one embodiment of the present disclosure;

FIG. 5 is a circuit diagram of the driving circuit according to at least one embodiment of the present disclosure;

FIG. 6A is a circuit diagram of the driving circuit according to at least one embodiment of the present disclosure;

FIG. 6B is a circuit diagram of the driving circuit according to at least one embodiment of the present disclosure;

FIG. 7 is a circuit diagram of the driving circuit according to at least one embodiment of the present disclosure;

FIG. 8 is a circuit diagram of the driving circuit according to at least one embodiment of the present disclosure;

FIG. 9 is a block diagram of the driving circuit according to at least one embodiment of the present disclosure;

FIG. 10 is a block diagram of the driving circuit according to at least one embodiment of the present disclosure;

FIG. 11 is a circuit diagram of the driving circuit according to at least one embodiment of the present disclosure;

FIG. 12 is a sequence diagram of the driving circuit in FIG. 11;

FIG. 13 is a circuit diagram of the driving circuit according to at least one embodiment of the present disclosure;

FIG. 14 is a simulation sequence diagram of the driving circuit in FIG. 13;

FIG. 15 is a block diagram of a pixel circuit according to at least one embodiment of the present disclosure;

FIG. 16 is a block diagram of the pixel circuit according to at least one embodiment of the present disclosure;

FIG. 17 is a block diagram of the pixel circuit according to at least one embodiment of the present disclosure;

FIG. 18 is a block diagram of the pixel circuit according to at least one embodiment of the present disclosure;

FIG. 19 is a block diagram of the pixel circuit according to at least one embodiment of the present disclosure;

FIG. 20 is a circuit diagram of the pixel circuit according to at least one embodiment of the present disclosure;

FIG. 21A is a sequence diagram of the pixel circuit in FIG. 20;

FIG. 21B is a sequence diagram of the pixel circuit in FIG. 20;

FIG. 22 is a circuit diagram of the pixel circuit according to at least one embodiment of the present disclosure;

FIG. 23 is a circuit diagram of the pixel circuit according to at least one embodiment of the present disclosure;

FIG. 24 is a circuit diagram of the pixel circuit according to at least one embodiment of the present disclosure;

FIG. 25 is a schematic view showing a display panel according to at least one embodiment of the present disclosure;

FIG. 26 is a schematic view showing the display panel according to at least one embodiment of the present disclosure; and

FIG. 27 is a schematic view showing the display panel according to at least one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

All transistors adopted in the embodiments of the present disclosure may be TFTs, field effect transistors (FETs) or any other elements having an identical characteristic. In order to differentiate two electrodes other than a gate electrode from each other, one of the two electrodes is called as first electrode and the other is called as second electrode.

In actual use, in a case that the transistor is a TFT or FET, the first electrode may be a drain electrode while the second electrode may be a source electrode, or the first electrode may be a source electrode while the second electrode may be a drain electrode.

The present disclosure provides in some embodiments a driving circuit, which includes a first switching circuit and a scanning signal generation circuit. The first switching circuit is electrically coupled to a first gating control line, a data output end of a source driver and the scanning signal generation circuit, and configured to control to write a data signal provided by the data output end into the scanning signal generation circuit under the control of a first gating control signal provided by the first gating control line. The scanning signal generation circuit is configured to generate a scanning signal in accordance with the data signal, and output the scanning signal through a scanning signal output end.

In the embodiments of the present disclosure, the driving circuit includes the first switching circuit and the scanning signal generation circuit. Within at least a part of a blank time period between two display frames, the first switching circuit controls to write the data signal provided by the data output end into the scanning signal generation circuit under the control of the first gating control signal. The scanning signal generation circuit generates the scanning signal in accordance with the data signal, and provides the scanning signal to a scanning line included in a display panel, so that a transistor coupled to the scanning line is controlled to be turned on or off within a next display frame in accordance with the scanning signal.

During the implementation, in a case that the transistor coupled to the scanning line is turned off within the next display frame, no data voltage is written into a pixel circuit where the transistor is located, and original display brightness is maintained through a transistor with a low leakage current, so as to prevent a waste of the power consumption caused by the repeated refreshing and writing of the pixel circuit.

In a case that the transistor coupled to the scanning line is turned on within the next display frame, a data voltage is written into the pixel circuit where the transistor is located, so as to refresh an image normally.

In a case of updating an image on an existing OLED display, all pixel circuits need to be initialized and the data voltage needs to be written within one display frame. In some special images (e.g., an Always On Display (AOD) image, a static image or an image which is seldom updated), the data voltages for a vast majority of the pixel circuits of an entire screen do not need to be updated, and the original display brightness may be maintained through an LTPO TFT with a low leakage current, so the repeated refreshing and writing of these pixel circuits leads to a waste of the power consumption of data lines.

Based on the above, in the embodiments of the present disclosure, a driving circuit is designed to control the scanning line on one scanning line within at least a part of the blank time period between two display frames, so as to turn on or off the transistor coupled to the scanning line within the next display frame in accordance with the scanning line, thereby to control whether or not to refresh the data voltage for the corresponding pixel circuit. In this way, it is able to locally update an image on the screen without any necessity to perform charging and discharging for the other images multiple times, thereby to further reduce the power consumption of the OLED display, or locally update a display image to achieve ultra-low power consumption.

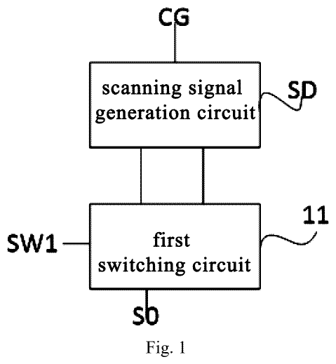

As shown in FIG. 1, the driving circuit in the embodiments of the present disclosure includes a first switching circuit 11 and a scanning signal generation circuit SD.

The first switching circuit 11 is electrically coupled to a first gating control line SW1, a data output end S0 of a source driver and the scanning signal generation circuit SD, and configured to control to write a data signal provided by the data output end S0 into the scanning signal generation circuit SD under the control of a first gating control signal provided by the first gating control line SW1.

The scanning signal generation circuit SD is configured to generate a scanning signal in accordance with the data signal, and output the scanning signal through a scanning signal output end CG.

In at least one embodiment of the present disclosure, the first switching circuit 11 is electrically coupled to one data output end of the source driver.

In a possible embodiment of the present disclosure, the first switching circuit includes a first transistor and a first capacitor, and the first switching circuit provides the data signal to the scanning signal generation circuit through a control node. A gate electrode of the first transistor is electrically coupled to the first gating control line, a first electrode of the first transistor is electrically coupled to the data output end, and a second electrode of the first transistor is electrically coupled to the control node. A first end of the first capacitor is electrically coupled to the control node, and a second end of the first capacitor is electrically coupled to a direct-current voltage end.

In at least one embodiment of the present disclosure, the data output end is directly electrically coupled to a data line, and the scanning signal output end is electrically coupled to a scanning line. However, the present disclosure is not limited thereto.

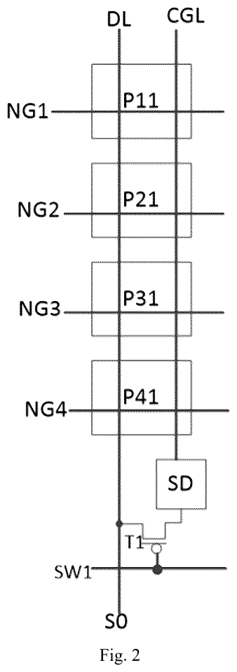

In FIG. 2, P11 represents a pixel circuit in a first row and a first column, P21 represents a pixel circuit in a second row and the first column, P31 represents a pixel circuit in a third row and the first column, P41 represents a pixel circuit in a fourth row and the first column, DL represents the data line, CG represents the scanning line, NG1 represents a first gate line in a first row, NG2 represents a first gate line in a second row, NG3 represents a first gate line in a third row, and NG4 represents a first gate line in a fourth row.

In at least one embodiment of the present disclosure, the driving circuit includes a first switching circuit and a scanning signal generation circuit SD. The first switching circuit includes a first transistor T1, a gate electrode of the first transistor T1 is electrically coupled to the first gating control line SW1, a source electrode of the first transistor T1 is electrically coupled to the data line DL, and a second electrode of the first transistor is electrically coupled to the scanning signal generation circuit SD. The data line DL is electrically coupled to a data output end S0 of the source driver. The scanning signal generation circuit SD is configured to generate a scanning signal in accordance with a data signal provided by the data output end S0 and provide the scanning signal to the scanning line CGL.

In at least one embodiment of the present disclosure, as shown in FIG. 2, T1 is a p-type transistor, and SW1 provides a low voltage signal between two display frames, so as to turn on T1.

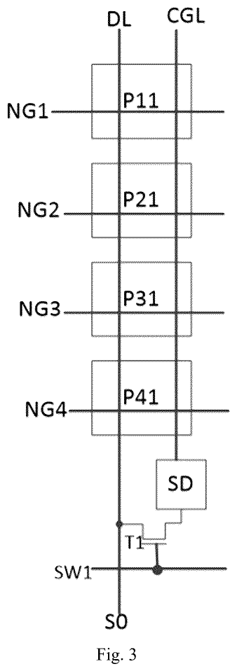

FIG. 3 differs from FIG. 2 in that T1 is an n-type transistor, and SW1 provides a high voltage signal between two display frames, so as to turn on T1.

In at least one embodiment of the present disclosure, the driving circuit further includes a second switching circuit, the second switching circuit is electrically coupled to a second gating control line, the data output end and a data line included in a display panel, and configured to control the data output end to be electrically coupled to, or electrically decoupled from, the data line under the control of a second gating control signal provided by the second gating control line. The first gating control line and the second gating control line are a same gating control line, or the first gating control line is different from the second gating control line.

During the implementation, the driving circuit further includes the second switching circuit, and the second switching circuit controls the data output end to be electrically coupled to, or electrically decoupled from, the data line under the control of the second gating control signal.

In a possible embodiment of the present disclosure, the second switching circuit includes a second transistor, a gate electrode of the second transistor is electrically coupled to the second gating control line, a first electrode of the second transistor is electrically coupled to the data output end, and a second electrode of the second transistor is electrically coupled to the data line.

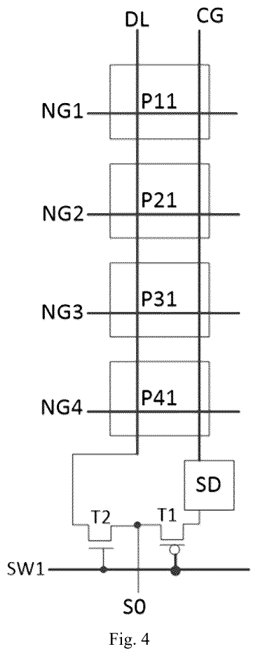

In FIG. 4, P11 represents a pixel circuit in a first row and a first column, P21 represents a pixel circuit in a second row and the first column, P31 represents a pixel circuit in a third row and the first column, P41 represents a pixel circuit in a fourth row and the first column, DL represents a data line, CG represents a scanning line, NG1 represents a first gate line in third row, and NG4 represents a first gate line in a fourth row.

In at least one embodiment of the present disclosure, the driving circuit includes a first switching circuit, a second switching circuit and a scanning signal generation circuit SD. The first switching circuit includes a first transistor T1, a gate electrode of T1 is electrically coupled to the first gating control line SW1, a source electrode of T1 is electrically coupled to the data output end S0 of the source driver, and a drain electrode of T1 is electrically coupled to the scanning signal generation circuit SD. The second switching circuit 13 includes a second transistor T2, a gate electrode of T2 is electrically coupled to the first gating control line SW1, a source electrode of T2 is electrically coupled to the data line DL, and a drain electrode of T2 is electrically coupled to the data output end S0 of the source driver. The scanning signal generation circuit SD is configured to generate a scanning signal in accordance with a data signal provided by the data output end S0 and provides the scanning signal to the scanning line CGL.

In at least one embodiment of the present disclosure, as shown in FIG. 4, T1 is a p-type transistor, and T2 is an n-type transistor.

In at least one embodiment of the present disclosure, as shown in FIG. 4, during the operating, within at least a part of a blank time period between two display frames, SW1 provides a low voltage signal, and T1 is turned on, so as to write the data signal provided by the data output end S0 into the scanning signal generation circuit SD. The scanning signal generation circuit SD generates the scanning signal in accordance with the data signal provided by the data output end S0, and provides the scanning signal to the scanning line CGL.

Within one display frame, SW1 provides a high voltage signal, and T2 is turned on, so as to control the data output end S0 to be electrically coupled to the data line DL.

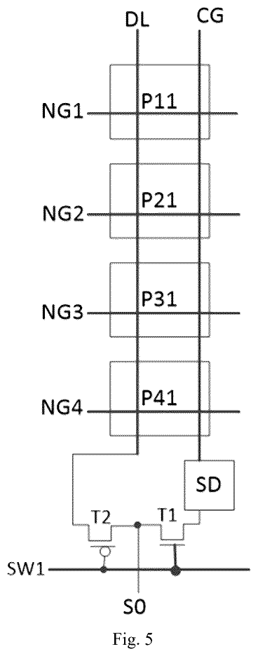

FIG. 5 differs from FIG. 4 in that T1 is an n-type transistor and T2 is a p-type transistor.

In at least one embodiment of the present disclosure, as shown in FIG. 5, during the operation, within at least a part of a blank time period between two display frames, SW1 provides a high voltage signal, and T1 is turned on, so as to write the data signal provided by the data output end S0 into the scanning signal generation circuit SD. The scanning signal generation circuit SD generates the scanning signal in accordance with the data signal provided by the data output end S0, and provides the scanning signal to a first scanning line CG1.

Within one display frame, SW1 provides a low voltage signal, and T2 is turned on, so as to control the data output end S0 to be electrically coupled to the data line DL.

In at least one embodiment of the present disclosure, as shown in FIGS. 4 and 5, the first gating control line and the second gating control line are a same gating control line.

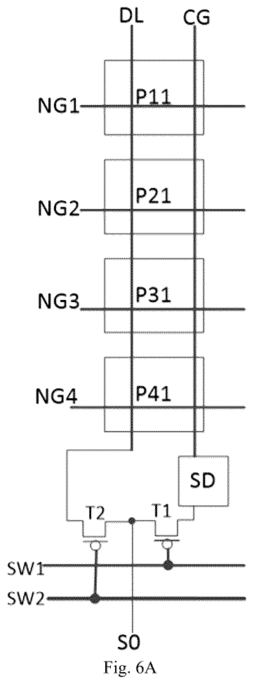

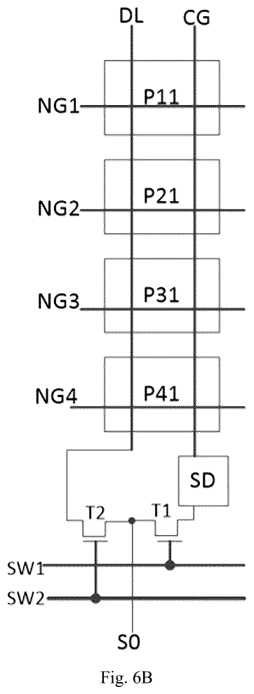

In FIG. 6A, P11 is a pixel circuit in a first row and a first column, P1 is a pixel circuit in a second row and a first column, P31 is a pixel circuit in a third row and a first column, P41 is a pixel circuit in a fourth row and a first column, DL represents a data line, CG represents a scanning line, NG1 represents a first gate line a first row, NG2 represents a first gate line in a second row, NG3 represents a first gate line in a third row, and NG4 represents a first gate line in a fourth row.

In at least one embodiment of the present disclosure, the driving circuit includes a first switching circuit, a second switching circuit and a scanning signal generation circuit SD. The first switching circuit includes a first transistor T1, a gate electrode of T1 is electrically coupled to the first gating control line SW1, a source electrode of T1 is electrically coupled to the data line DL, and a drain electrode of T1 is electrically coupled to the scanning signal generation circuit SD. The second switching circuit 13 includes a second transistor T2, a gate electrode of T2 is electrically coupled to the second gating control line SW2, a source electrode of T2 is electrically coupled to the data line DL, and a drain electrode of T2 is electrically coupled to the data output end S0 of the source driver. The scanning signal generation circuit SD generates a scanning signal in accordance with the data signal provided by the data output end SO, and provides the scanning signal to the scanning line CGL.

In at least one embodiment of the present disclosure, as shown in FIG. 6A, the first gating control line is different from the second gating control line.

In at least one embodiment of the present disclosure, as shown in FIG. 6A, T1 is a p-type transistor and T2 is a p-type transistor.

In at least one embodiment of the present disclosure, as shown in FIG. 6A, during the operation, within at least a part of blank time period between two display frames, SW1 provides a low voltage signal, SW2 provides a high voltage signal, and T1 is turned on, so as to write the data signal provided by the data output end S0 into the scanning signal generation circuit SD. The scanning signal generation circuit SD generates a scanning signal in accordance with the data signal provided by the data output end S0 and provides the scanning signal to the scanning line CGL.

Within one display frame, SW2 provides a low voltage signal, SW1 provides a high voltage signal, and T2 is turned on, so as to control the data output end S0 to be electrically coupled to the data line DL.

FIG. 6B differs from FIG. 6A in that T1 is an n-type transistor and T2 is an n-type transistor.

In at least one embodiment of the present disclosure, as shown in FIG. 6B, during the operation, within at least a part of a blank time period between two display frames, SW1 provides a high voltage signal, SW2 provides a low voltage signal, and T1 is turned on, so as to write the data signal provided by the data output end S0 into the scanning signal generation circuit SD. The scanning signal generation circuit SD generates a scanning signal in accordance with the data signal provided by the data output end S0, and provides the scanning signal to the scanning line CGL.

Within one display frame, SW2 provides a high voltage signal, SW1 provides a low voltage signal, and T2 is turned on, so as to control the data output end S0 to be electrically coupled to the data line DL.

In at least one embodiment of the present disclosure, as shown in FIGS. 2 to 6B, the scanning signal generation circuit and the source driver are arranged at a same side of the display panel. In actual use, the scanning signal generation circuit and the source driver are arranged at opposite sides of the display panel.

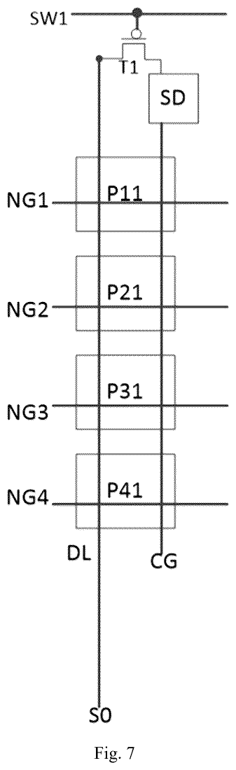

FIG. 7 differs from FIG. 2 in that T1 and the scanning signal generation circuit are arranged at an upper side of the display panel.

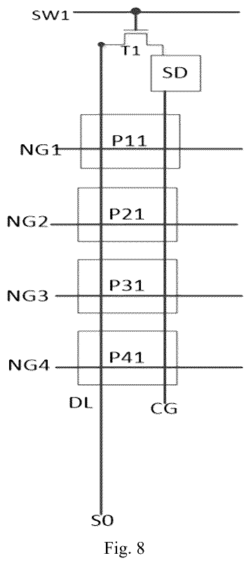

FIG. 8 differs from FIG. 3 in that T1 and the scanning signal generation circuit are arranged at the upper side of the display panel.

In at least one embodiment of the present disclosure, the scanning signal generation circuit includes an output control circuit and an output circuit, and the first switching circuit provides the data signal to the scanning signal generation circuit through a control node. The output control circuit is electrically coupled to the control node, a first voltage end, a second voltage end, an output control end and a scanning output end, and configured to control the output control end to be electrically coupled to, or electrically decoupled from, the first voltage end under the control of a potential at the control node, and control the output control end to be electrically coupled to, or electrically decoupled from, the second voltage end under the control of a signal provided by the scanning output end. The output circuit is electrically coupled to a control end, the scanning output end, the output control end, the first voltage end and the second voltage end, and configured to control the scanning output end to be electrically coupled to, or electrically decoupled from, the first voltage end under the control of a control signal provided by the control end, and control the scanning output end to be electrically coupled to, or electrically decoupled from, the second voltage end under the control of a potential at the output control end.

During the implementation, the scanning signal generation circuit includes the output control circuit and the output circuit. The output control circuit controls the output control end to be electrically coupled to, or electrically decoupled from, the first voltage end under the control of the potential at the control node, and controls the output control end to be electrically coupled to, or electrically decoupled from, the second voltage end under the control of the signal provided by the scanning output end. The output circuit controls the scanning output end to be electrically coupled to, or electrically decoupled from, the first voltage end under the control of the control signal provided by the control end, and controls the scanning output end to be electrically coupled to, or electrically decoupled from, the second voltage end under the control of the potential at the output control end.

In a possible embodiment of the present disclosure, the scanning output end is the scanning signal output end; or the scanning signal generation circuit further includes a phase inverting circuit, an input end of the phase inverting circuit is electrically coupled to the scanning output end, an output end of the phase inverting circuit is electrically coupled to the scanning signal output end, and the phase inverting circuit is configured to invert a phase of a voltage signal received by the input end of the phase inverting circuit to obtain a phase-inverted voltage signal, and output the phase-inverted voltage signal through the output end of the phase inverting circuit.

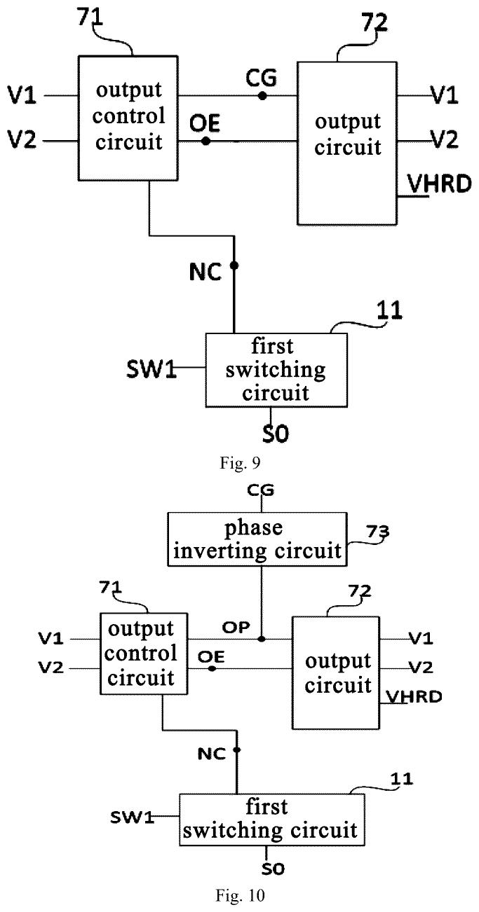

As shown in FIG. 9, the first switching circuit 11 is electrically coupled to a first gating control line SW1, a data output end S0 of a source driver and a control node NC, and configured to control the data output end S0 to be electrically coupled to, or electrically decoupled from, the control node NC under the control of a first gating control signal provided by the first gating control line SW1. The scanning signal generation circuit includes an output control circuit 71 and an output circuit 72. The output control circuit 71 is electrically coupled to the control node NC, a first voltage end V1, a second voltage end V2, an output control end OE and a scanning signal output end CG, and configured to control the output control end OE to be electrically coupled to, or electrically decoupled from, the first voltage end V1 under the control of a potential at the control node NC, and control the output control end OE to be electrically coupled to, or electrically decoupled from, the second voltage end V2 under the control of a signal provided by the scanning signal output end CG. The output circuit 72 is electrically coupled to a control end VHRD, the output control end OF, the scanning signal output end CG, the first voltage end V1 and the second voltage end V2, and configured to control the scanning signal output end CG to be electrically coupled to, or electrically decoupled from, the first voltage end V1 under the control of a potential of a control signal provided by the control end VHRD, and control the scanning signal output end CG to be electrically coupled to, or electrically decoupled from, the second voltage end V2 under the control of a potential at the output control end OE.

In the scanning signal generation circuit as shown in FIG. 9, the scanning output end is the scanning signal output end CG, the first voltage end is a high voltage end, and the second voltage is a low voltage end. However, the present disclosure is not limited thereto.

As shown in FIG. 10, the first switching circuit 11 is electrically coupled to a first gating control line SW1, a data output end S0 of the source driver and a control node NC, and configured to control the data output end S0 to be electrically coupled to, or electrically decoupled from, the control node NC under the control of a first gating control signal provided by the first gating control line SW1. The scanning signal generation circuit includes an output control circuit 71 and an output circuit 72. The output control circuit 71 is electrically coupled to the control node NC, a first voltage end V1, a second voltage end V2, an output control end OE and a scanning output end OP, and configured to control the output control end OE to be electrically coupled to, or electrically decoupled from, the first voltage end V1 under the control of a potential at the control node NC1, and control the output control end OE to be electrically coupled to, or electrically decoupled from, the second voltage end under the control of a signal provided by the scanning output end OP. The output circuit 72 is electrically coupled to a control end VHRD, the scanning output end OP, the output control end OE, the first voltage end V1 and the second voltage end V2, and configured to control the scanning output end OP to be electrically coupled to, or electrically decoupled from, the first voltage end V1 under the control of a potential at the control end VHRD, and control the scanning output end OP to be electrically coupled to, or electrically decoupled from, the second voltage end V2 under the control of a potential at the output control end OF. The scanning signal generation circuit further includes a phase inverting circuit 73, an input end of the phase inverting circuit 73 is electrically coupled to the scanning output end OP, an output end of the phase inverting circuit 73 is electrically coupled to the scanning signal output end CG, and the phase inverting circuit 73 is configured to invert a phase of a voltage signal received by the input end of the phase inverting circuit 73 to obtain a phase-inverted voltage signal, and output the phase-inverted voltage signal through the output end of the phase inverting circuit 73.

In a possible embodiment of the present disclosure, the output control circuit includes a third transistor and a fourth transistor. A gate electrode of the third transistor is electrically coupled to the control node, a first electrode of the third transistor is electrically coupled to the first voltage end, and a second electrode of the third transistor is electrically coupled to the output control end. A gate electrode of the fourth transistor is electrically coupled to the scanning output end, a first electrode of the fourth transistor is electrically coupled to the output control end, and a second electrode of the fourth transistor is electrically coupled to the second voltage end. The output circuit includes a fifth transistor, a sixth transistor and a second capacitor. A gate electrode of the fifth transistor is electrically coupled to the control end, a first electrode of the fifth transistor is electrically coupled to the first voltage end, and a second electrode of the fifth transistor is electrically coupled to the scanning output end. A gate electrode of the sixth transistor is electrically coupled to the output control end, a first electrode of the sixth transistor is electrically coupled to the scanning output end, and a second electrode of the sixth transistor is electrically coupled to the second voltage end. A first end of the second capacitor is electrically coupled to the control end, and a second end of the second capacitor is electrically coupled to the second voltage end.

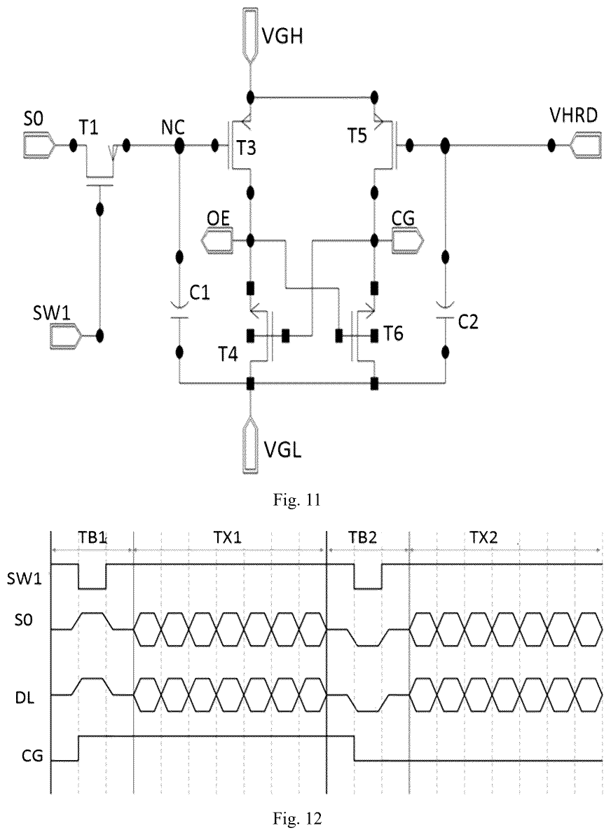

As shown in FIG. 11, based on FIG. 9, the first switching circuit includes a first transistor T1 and a first capacitor C1. A gate electrode of the first transistor T1 is electrically coupled to the first gating control line SW1, a source electrode of the first transistor T1 is electrically coupled to the data output end SO, and a drain electrode of the first transistor T1 is electrically coupled to a control node NC. A first end of the first capacitor C1 is electrically coupled to the control node NC, and a second end of the first capacitor C1 is electrically coupled to a low voltage end VGL.

The output control circuit includes a third transistor T3 and a fourth transistor T4. A gate electrode of the third transistor T3 is electrically coupled to the control node NC, a source electrode of the third transistor T3 is electrically coupled to a high voltage end VGH, and a drain electrode of the third transistor T3 is electrically coupled to the output control end OE. A gate electrode of the fourth transistor T4 is electrically coupled to the scanning signal output end CG, a source electrode of the fourth transistor T4 is electrically coupled to the output control end OE, and a drain electrode of the fourth transistor T4 is electrically coupled to the low voltage end VGL.

The output circuit includes a fifth transistor T5, a sixth transistor T6 and a second capacitor C2. A gate electrode of the fifth transistor T5 is electrically coupled to a control end VHRD, a source electrode of the fifth transistor T5 is electrically coupled to the high voltage end VGH, and a drain electrode of the fifth transistor T5 is electrically coupled to the scanning signal output end CG. A gate electrode of the sixth transistor T6 is electrically coupled to the output control end OE, a source electrode of the sixth transistor T6 is electrically coupled to the scanning signal output end CG, and a drain electrode of the sixth transistor T6 is electrically coupled to the low voltage end VGL. A first end of the second capacitor C2 is electrically coupled to the control end VHRD, and a second end of the second capacitor C2 is electrically coupled to the low voltage end VGL.

In the scanning signal generation circuit as shown in FIG. 11, the control voltage end is the second voltage end, the first voltage end is the high voltage end, and the second voltage end is the low voltage end. However, the present disclosure is not limited thereto.

In the scanning signal generation circuit as shown in FIG. 11, S0 is electrically coupled to a corresponding data line DL.

In at least one embodiment of the present disclosure, as shown in FIG. 11, T1 is a p-type transistor, T3 is a p-type transistor, T4 is an n-type transistor, T5 is a p-type transistor, and T6 is an n-type transistor.

In at least one embodiment of the present disclosure, as shown in FIG. 11, the control end VHRD provides a 3V voltage signal, the high voltage end VGH provides an 8V voltage signal, and the low voltage end VGL provides a −8V voltage signal.

In at least one embodiment of the present disclosure, a voltage value of a control signal provided by the control end VHRD is greater than or equal to 3V and smaller than or equal to 4V, a voltage value of a high voltage signal provided by the high voltage end VGH is greater than or equal to 7V or smaller than or equal to 9V, and a voltage value of a low voltage signal provided by the low voltage end VGL is greater than or equal to −9V and smaller than or equal to-7V. However, the present disclosure is not limited thereto.

As shown in FIG. 12, during the operation of the driving circuit in FIG. 11, TB1 represents a first blank time period, TB2 represents a second control time period, TX represents a first data write-in time period, and TX2 represents a second data write-in time period. Within a part of the first blank time period TB1, SW1 provides a low voltage signal so as to turn on T1. S0 provides a high voltage signal, the data line DL receives a high voltage signal, and a potential at NC is a high voltage, so T5 is turned on. CG is electrically coupled to VGH, and a potential at CG is a high voltage, so T4 is turned on and OE is electrically coupled to VGL. At this time, OE outputs a low voltage signal. Within the first data write-in time period TX1, the potential at CG is maintained as a high voltage. Within a part of the second blank time period TB2, SW1 provides a low voltage signal, so T1 is turned on. S0 provides a low voltage signal, DL receives a low voltage signal, and the potential at NC is a low voltage, so T3 is turned on. OE is electrically coupled to VGH, and a potential at OE is a high voltage, so T6 is turned on. At this time, CG outputs a low voltage signal. Within the second data write-in time period TX2, the potential at CG is maintained as a low voltage.

As shown in FIG. 11, during the operation, within a part of the first blank time period TB1, a voltage of a high voltage signal received by DL is 7V, and within a part of the second blank time period TB2, a voltage value of a low voltage signal received by DL is 0V. However, the present disclosure is not limited thereto.

As shown in FIG. 11, during the operation, within a part of the second blank time period TB2, T6 is turned on at a level higher than T5, so CG outputs a low voltage signal.

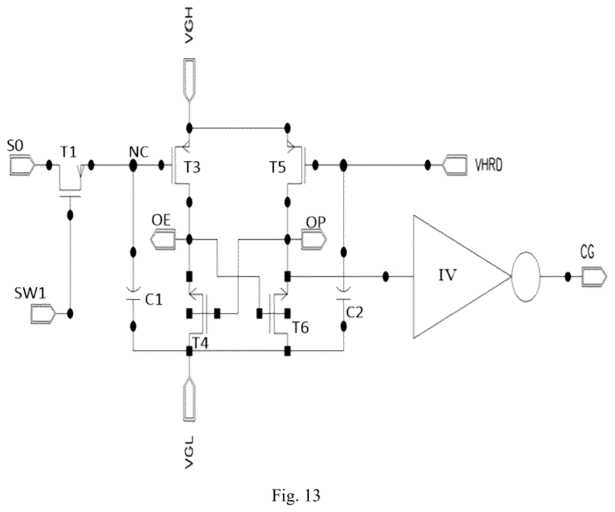

As shown in FIG. 13, based on FIG. 10, the first switching circuit includes a first transistor T1 and a first capacitor C1. A gate electrode of the first transistor T1 is electrically coupled to the first gating control line SW1, a source electrode of the first transistor T1 is electrically coupled to the data output end S0, and a drain electrode of the first transistor T1 is electrically coupled to the control node NC. A first end of the first capacitor C1 is electrically coupled to the control node NC, and a second end of the first capacitor C1 is electrically coupled to the low voltage end VGL.

The output control circuit includes a third transistor T3 and a fourth transistor T4. A gate electrode of the third transistor T3 is electrically coupled to the control node NC, a source electrode of the third transistor T3 is electrically coupled to the high voltage end VGH, and a drain electrode of the third transistor T3 is electrically coupled to the output control end OE. A gate electrode of the fourth transistor T4 is electrically coupled to the control node NC, a source electrode of the fourth transistor T4 is electrically coupled to the output control end OE, and a drain electrode of the fourth transistor T4 is electrically coupled to the low voltage end VGL.

The output circuit includes a fifth transistor T5 and a sixth transistor T6. A gate electrode of the fifth transistor T5 is electrically coupled to the control end VHRD, a source electrode of the fifth transistor T5 is electrically coupled to the high voltage end VGH, and a drain electrode of the fifth transistor T5 is electrically coupled to the scanning output end OP. A gate electrode of sixth transistor T6 is electrically coupled to the output control end OF, a source electrode of the sixth transistor T6 is electrically coupled to the scanning output end OP, and a drain electrode of the sixth transistor T6 is electrically coupled to the low voltage end VGL.

The phase inverting circuit includes a phase inverter IV, an input end of the phase inverter IV is electrically coupled to the scanning output end OP, an output end of the phase inverter IV is electrically coupled to the scanning signal output end CG, and the phase inverter IV is configured to invert a phase of a voltage signal received by an input end of the phase inverter IV to obtain a phase-inverted voltage signal, and output the phase-inverted voltage signal through an output end of the phase inverter IV.

In at least one embodiment of the present disclosure, in the scanning signal generation signal as shown in FIG. 13, the first voltage end is a high voltage end, and the second voltage end is a low voltage end. However, the present disclosure is not limited thereto.

In at least one embodiment of the present disclosure, in the scanning signal generation signal as shown in FIG. 13, S0 is electrically coupled to the data line DL.

In at least one embodiment of the present disclosure, as shown in FIG. 13, the control end VHRD provides a 3V voltage signal, the high voltage end VGH provides an 8V voltage signal, and the low voltage end VGL provides a −8V voltage signal.

In at least one embodiment of the present disclosure, during the operation of the scanning signal generation circuit in FIG. 13, a first blank time period, a first data write-in time period, a second blank time period and a second data write-in time period are arranged one after another.

Within at least a part of the first blank time period, SW1 provides a low voltage signal, so T1 is turned on. S0 provides a high voltage signal, DL receives a high voltage signal, and a potential at NC is a high voltage, so T5 is turned on. OP is electrically coupled to VGH, and a potential at OP is a high voltage, so T4 is turned on and OE is electrically coupled to VGL. At this time, OE outputs a low voltage signal, and CG outputs a low voltage signal. Within the first data write-in time period, a potential at CG is maintained as a low voltage. Within at least a part of the second blank time period, SW1 provides a low voltage signal, so T1 is turned on. S0 provides a low voltage signal, DL receives a low voltage signal, and a potential at NC is a low voltage, so T3 is turned on. OE is electrically coupled to VGH, and a potential at OE is a high voltage, so T6 is turned on. At this time, OP outputs a low voltage signal, and CG outputs a high voltage signal. Within the second data write-in time period, the potential at CG is maintained as a high voltage.

In at least one embodiment of the present disclosure, as shown in FIG. 13, during the operation, within a part of the first blank time period, a voltage of a high voltage signal received by DL is 7V, and within a part of the second blank time period TB2, a voltage value of a low voltage signal received by DL is 0V. However, the present disclosure is not limited thereto.

In at least one embodiment of the present disclosure, as shown in FIG. 13, during the operation, within a part of the second blank time period, T6 is turned on at a level higher than T5, so OP outputs a low voltage signal.

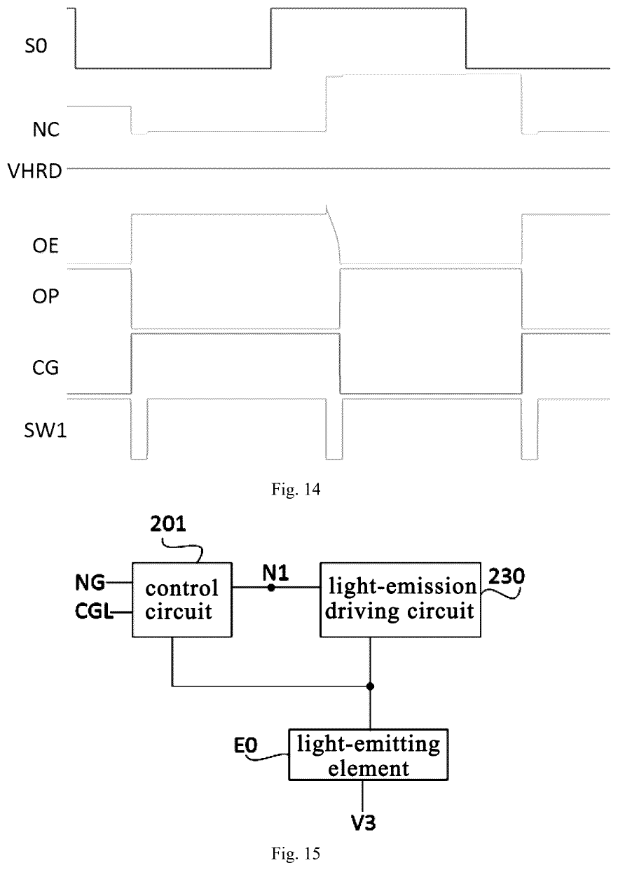

FIG. 14 is a simulation sequence diagram of the scanning signal generation circuit in FIG. 13.

The present disclosure further provides in some embodiments a driving method for the above-mentioned driving circuit, which includes, within at least a part of a blank time period between two display frames: controlling, by a first switching circuit, to write a data signal provided by a data output end of a source driver into a scanning signal generation circuit under the control of a first gating control signal; and generating, by the scanning signal generation circuit, a scanning signal in accordance with the data signal, and outputting the scanning signal to a corresponding scanning line in a display panel through a scanning signal output end.

In the driving method according to the embodiments of the present disclosure, within at least a part of the blank time period between two display frames, the first switching circuit writes the data signal provided by the data output end of the source driver into the scanning signal generation circuit under the control of the first gating control signal, and the scanning signal generation circuit generates the scanning signal in accordance with the data signal provided by the data output end, and outputs the scanning signal to the corresponding scanning line in the display panel through the scanning signal output end.

In at least one embodiment of the present disclosure, the driving circuit further includes a second switching circuit, and the driving method further includes, within a data write-in time period in one display frame, controlling, by the second switching circuit, the data output end of the source driver to be electrically coupled to a corresponding data line in the display panel under the control of a second gating control signal.

During the implementation, the driving circuit further includes the second switching circuit, and within the data write-in time period in one display frame, the second switching circuit controls the data output end to be electrically coupled to the corresponding data line in the display panel under the control of the second gating control signal, so as to provide a data voltage to the data line.

The present disclosure further provides in some embodiments a pixel circuit, which includes a light-emitting element, a light-emission driving circuit and a control circuit. The light-emission driving circuit is electrically coupled to a first node and a first electrode of the light-emitting element and configured to generate a driving current for driving the light-emitting element under the control of a potential at the first node, and a second electrode of the light-emitting element is electrically coupled to a third voltage end. The control circuit is electrically coupled to a first gate line, a scanning line, the first node and the first electrode of the light-emitting element, and configured to control the first node to be electrically coupled to, or electrically decoupled from, the first electrode of the light-emitting element under the control of a first gate driving signal provided by the first gate line and a scanning signal provided by the scanning line.

During the implementation, the pixel circuit includes the control circuit and the light-emission control circuit. The light-emission driving circuit generates the driving current under the control of the potential at the first node, and the control circuit controls the first node to be electrically coupled to, or electrically decoupled from, the first electrode of the light-emitting element under the control of the first gate driving signal provided by the first gate line and the scanning signal provided by the scanning line. The driving current is a current for driving the light-emitting element to emit light.

In at least one embodiment of the present disclosure, the third voltage end is, but not limited to, a low level end.

In a possible embodiment of the present disclosure, the light-emitting element is an OLED, a first electrode of the light-emitting element is an anode, and a second electrode of the light-emitting element is a cathode.

As shown in FIG. 15, the pixel circuit includes a light-emitting element E0, a control circuit 201 and a light-emission driving circuit 230. The light-emission driving circuit 230 is electrically coupled to a first node N1 and a first electrode of the light-emitting element E0, and configured to generate a driving current for driving the light-emitting element E0 under the control of a potential at the first node N1. A second electrode of the light-emitting element E0 is electrically coupled to a third voltage end V3. The control circuit 201 is electrically coupled to a first gate line NG, a scanning line CGL, the first node N1 and the first electrode of the light-emitting element E0, and configured to control the first node N1 to be electrically coupled to, or electrically decoupled from, the first electrode of the light-emitting element E0 under the control of a scanning signal provided by the scanning line CGL.

In at least one embodiment of the present disclosure, the control circuit includes a first control circuit and a second control circuit, a first end of the light-emission driving circuit is electrically coupled to a second node, and a second end of the light-emission driving circuit is electrically coupled to a third node and the first electrode of the light-emitting element. The first control circuit is electrically coupled to the first gate line, the first node and an intermediate node, and configured to control the first node to be electrically coupled to, or electrically decoupled from, the intermediate node under the control of the first gate driving signal provided by the first gate line. The second control circuit is electrically coupled to the scanning line, the intermediate node and the third node, and configured to control the intermediate node to be electrically coupled to, or electrically decoupled from, the third node under the control of the scanning signal provided by the scanning line.

During the implementation, the control circuit includes the first control circuit and the second control circuit, the first control circuit controls the first node to be electrically coupled to, or electrically decoupled from, the intermediate node under the control of the first gate driving signal provided by the first gate line, and the second control circuit controls the intermediate node to be electrically coupled to, or electrically decoupled from, the third node under the control of the scanning signal provided by the scanning line.

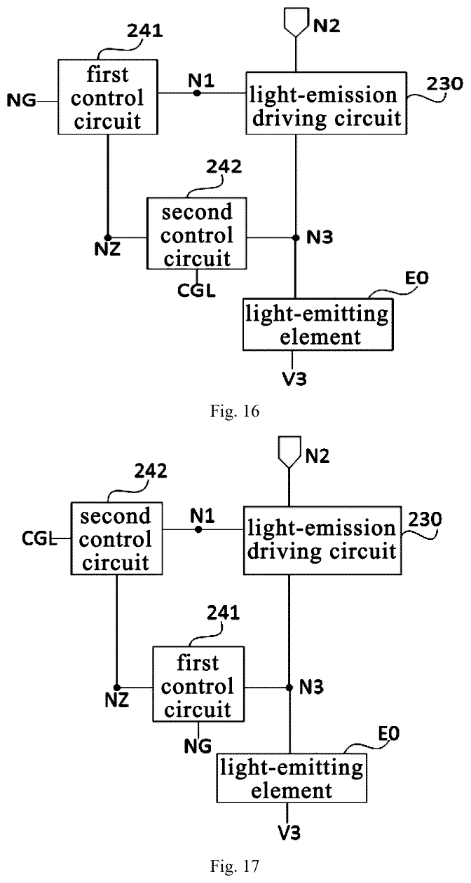

As shown in FIG. 16, based on the pixel circuit in FIG. 15, the control circuit includes a first control circuit 241 and a second control circuit 242, a first end of the light-emission driving circuit 230 is electrically coupled to a second node N2, and a second end of the light-emission driving circuit 230 is electrically coupled to a third node N3 and the first electrode of the light-emitting element E0. The first control circuit 241 is electrically coupled to the first gate line NG, the first node N1 and an intermediate node NZ, and configured to control the first node N1 to be electrically coupled to, or electrically decoupled from, the intermediate node NZ under the control of a first gate driving signal provided by the first gate line NG. The second control circuit 242 is electrically coupled to a scanning line CGL, the intermediate node NZ and the third node N3, and configured to control the intermediate node N1 to be electrically coupled to, or electrically decoupled from, the third node N3 under the control of a scanning signal provided by the scanning line CGL.

In at least one embodiment of the present disclosure, the control circuit includes a first control circuit and a second control circuit, a first end of the light-emission driving circuit is electrically coupled to a second node, and a second end of the light-emission driving circuit is electrically coupled to a third node and the first electrode of the light-emitting element. The first control circuit is electrically coupled to the first gate line, the third node and an intermediate node, and configured to control the third node to be electrically coupled to, or electrically decoupled from, the intermediate node under the control of the first gate driving signal provided by the first gate line. The second control circuit is electrically coupled to the scanning line, the intermediate node and the first node, and configured to control the intermediate node to be electrically coupled to, or electrically decoupled from, the first node under the control of the scanning signal provided by the scanning line.

During the implementation, the control circuit includes the first control circuit and the second control circuit, the first control circuit controls the third node to be electrically coupled to, or electrically decoupled from, the intermediate node under the control of the first gate driving signal provided by the first gate line, and the second control circuit controls the intermediate node to be electrically coupled to, or electrically decoupled from, the first node under the control of the scanning signal provided by the scanning line.

As shown in FIG. 17, based on the pixel circuit in FIG. 15, the control circuit includes a first control circuit 241 and a second control circuit 242, a first end of the light-emission driving circuit 230 is electrically coupled to a second node N2, and a second end of the light-emission driving circuit 230 is electrically coupled to a third node N3 and the first electrode of the light-emitting element E0. The first control circuit 241 is electrically coupled to the first gate line NG, the third node N3 and an intermediate node NZ, and configured to control the third node N3 to be electrically coupled to, or electrically decoupled from, the intermediate node NZ under the control of the first gate driving signal provided by the first gate line NG. The second control circuit 242 is electrically coupled to the scanning line CGL, the intermediate node NZ and the first node N1, and configured to control the intermediate node NZ to be electrically coupled to, or electrically decoupled from, the first node N1 under the control of the scanning signal provided by the scanning line CGL.

In at least one embodiment of the present disclosure, the pixel circuit further includes a first initialization circuit, a first end of the light-emission driving circuit is electrically coupled to a second node, and a second end of the light-emission driving circuit is electrically coupled to a third node and the first electrode of the light-emitting element. The first initialization circuit is electrically coupled to a first initial control end, a first initial voltage end and the second node, and configured to write a first initial voltage provided by the first initial voltage end into the second node under the control of a first initial control signal provided by the first initial control end.

During the implementation, a display period includes a first initialization time period and a second initialization time period arranged one after another. Within the first initialization time period, the control circuit controls the first node to be electrically coupled to the third node under the control of the first gate driving signal and the scanning line, the first initialization circuit writes a first initial voltage into the second node under the control of the first initial control signal, and the light-emission driving circuit controls the second node to be electrically coupled to the third node under the control of a potential at the first node. Within the second initialization time period, the control circuit controls the first node to be electrically decoupled from the third node under the control of the first gate driving signal and the scanning signal, the first initialization circuit writes the first initial voltage into the second under the control of the first initial control signal, and the light-emission driving circuit controls the second node to be electrically coupled to the third node under the control of the potential at the first node.

In at least one embodiment of the present disclosure, during the operation of the pixel circuit, within the first initialization time period, before data writing, potentials at the first node, the second node and the third node are initialized, so as to reduce a subsequent charging difference. Within the second initialization time period, the first initialization circuit writes the first initial voltage into the second node, and the light-emission driving circuit controls the second node to be electrically coupled to the third node, so as to enable a driving transistor of the light-emitting driving circuit to be in a biased state, thereby to improve a hysteresis phenomenon.

In at least one embodiment of the present disclosure, the pixel circuit further includes a second initialization circuit, a first end of the light-emission driving circuit is electrically coupled to a second node, and a second end of the light-emission driving circuit is electrically coupled to a third node and the first electrode of the light-emitting element. The second initialization circuit is electrically coupled to a second initial control end, a second initial voltage end and the third node, and configured to write a second initial voltage provided by the second initial voltage end into the third node under the control of a second initial control signal provided by the second initial control end.

During the implementation, the pixel circuit further includes the second initialization circuit. Within a third initialization time period between the first initialization time period and the second initialization time period, before the data write-in time period, the second initialization circuit writes the second initial voltage into the third node under the control of the second initial control signal, so as to turn on the driving transistor of the light-emission driving circuit at the beginning of the data write-in time period, thereby to facilitate the writing of the data voltage as well as threshold voltage compensation.

In at least one embodiment of the present disclosure, the pixel circuit further includes a data write-in circuit, a first light-emission control circuit, a second light-emission control circuit and an energy storage circuit. A first end of the light-emission driving circuit is electrically coupled to a second node, and a second end of the light-emission driving circuit is electrically coupled to a third node and the first electrode of the light-emitting element. The data write-in circuit is electrically coupled to a second gate line, a data line and the second node, and configured to write a data voltage provided by the data line into the second node under the control of a second gate driving signal provided by the second gate line. The first light-emission control circuit is electrically coupled to a light-emission control line, a power source voltage end and the second node, and configured to control the power source voltage end to be electrically coupled to, or electrically decoupled from, the second node under the control of a light-emission control signal provided by the light-emission control line. The second light-emission control circuit is electrically coupled to the light-emission control line, the third node and the first electrode of the light-emitting element, and configured to control the third node to be electrically coupled to the first electrode of the light-emitting element under the control of the light-emission control signal. The energy storage circuit is electrically coupled to the first node, and configured to store electric energy.

During the implementation, the pixel circuit further includes the data write-in circuit, the first light-emission control circuit, the second light-emission control circuit and the energy storage circuit. The data write-in circuit is configured to write the data voltage into the second node, the first light-emission control circuit and the second light-emission control circuit are configured to enable a light-emitting path, and the energy storage circuit is configured to store electric energy.

In at least one embodiment of the present disclosure, the pixel circuit further includes a third initialization circuit, the third initialization circuit is electrically coupled to a first initial control end, a third initial control end and the first electrode of the light-emitting element, and configured to write a third initial voltage provided by the third initial voltage end into the first electrode of the light-emitting element under the control of a first initial control signal provided by the first initial control end.

During the implementation, the pixel circuit further includes the third initialization circuit, and the third initialization circuit writes the third initial voltage into the first electrode of the light-emitting element under the control of the first initial control signal, so as to control the light-emitting element not to emit light, and eliminate residual electric charges on the first electrode of the light-emitting element.

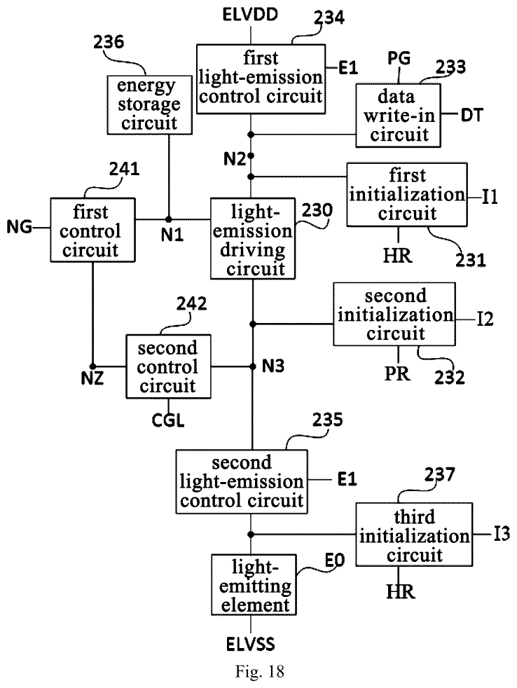

As shown in FIG. 18, based on the pixel circuit in FIG. 16, the pixel circuit further includes a first initialization circuit 231, a second initialization circuit 232, a data write-in circuit 233, a first light-emission control circuit 234, a second light-emission control circuit 235, an energy storage circuit 236 and a third initialization circuit 237. The second electrode of the light-emitting element E0 is electrically coupled to a low level end ELVSS. The first initialization circuit 231 is electrically coupled to a first initialization control end HR, a first initial voltage end I1 and the second node N2, and configured to write a first initial voltage Vinit1 provided by the first initial voltage end I1 into the second node N2 under the control of a first initial control signal provided by the first initial control end HR. The second initialization circuit 232 is electrically coupled to a second initial control end PR, a second initial voltage end 12 and the third node N3, and configured to write a second initial voltage Vinit2 provided by the second initial voltage end 12 into the third node N3 under the control of a second initial control signal provided by the second initial control end PR. The data write-in circuit 233 is electrically coupled to a second gate line PG, a data line DT and the second node N2, and configured to write a data voltage Vdata provided by the data line DT into the second node N2 under the control of a second gate driving signal provided by the second gate line PG. The first light-emission control circuit 234 is electrically coupled to a light-emission control line E1, a power source voltage end ELVDD and the second node N2, and configured to control the power source voltage end ELVDD to be electrically coupled to, or electrically decoupled from, the second node N2 under the control of a light-emission control signal provided by the light-emission control line E1. The second light-emission control circuit 234 is electrically coupled to the light-emission control line E1, the third node N3 and the first electrode of the light-emitting element E0, and configured to control the third node N3 to be electrically coupled to the first electrode of the light-emitting element E0 under the control of the light-emission control signal. The second electrode of the light-emitting element E0 is electrically coupled to a third voltage end V3. The energy storage circuit 236 is electrically configured to the first node N1, and configured to store electric energy. The third initialization circuit 237 is electrically coupled to a first initial control end HR, a third initial voltage end 13 and the first electrode of the light-emitting element E0, and configured to write a third initial voltage Vinit3 provided by the third initial voltage end 13 into the first electrode of the light-emitting element E0 under the control a first initial control signal provided by the first initial control end HR.

In the pixel circuit in FIG. 18, the third voltage end is a low level end ELVSS.

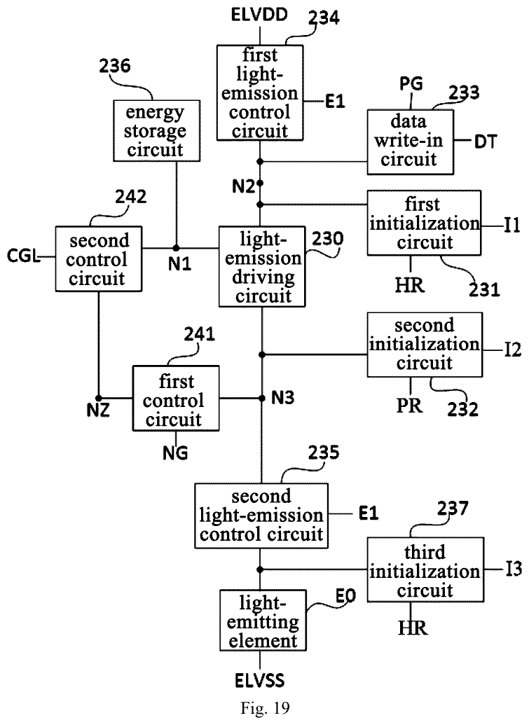

As shown in FIG. 19, based on the pixel circuit in FIG. 17, the pixel circuit further includes a first initialization circuit 231, a second initialization circuit 232, a data write-in circuit 233, a first light-emission control circuit 234, a second light-emission control circuit 235, an energy storage circuit 236 and a third initialization circuit 237. The second electrode of the light-emitting element E0 is electrically coupled to a low level end ELVSS.

The first initialization circuit 231 is electrically coupled to a first initial control end HR, a first initial voltage end I1 and the second node N2, and configured to write a first initial voltage Vinit1 provided by the first initial voltage end I1 into the second node N2 under the control of a first initial control signal provided by the first initial control end HR.

The second initialization circuit 232 is electrically coupled to a second initial control end PR, a second initial voltage end 12 and the third node N3, and configured to write a second initial voltage Vinit2 provided by the second initial voltage end 12 into the third node N3 under the control of a second initial control signal provided by the second initial control end PR.

The data write-in circuit 233 is electrically coupled to a second gate line PG, a data line DT and the third node N2, and configured to write a data voltage Vdata provided by the data line DT into the second node N2 under the control of a second gate driving signal provided by the second gate line PG.

The first light-emission control circuit 234 is electrically coupled to a light-emission control line E1, a power source voltage end ELVDD and the second node N2, and configured to control the power source voltage end ELVDD to be electrically coupled to, or electrically decoupled from, the second node N2 under the control of a light-emission control signal provided by the light-emission control line E1.

The second light-emission control circuit 235 is electrically coupled to the light-emission control line E1, the third node N3 and the first electrode of the light-emitting element E0, and configured to control the third node N3 to be electrically coupled to the first electrode of the light-emitting element E0 under the control the light-emission control signal. The second electrode of the light-emitting element E0 is electrically coupled to a third voltage end V3.

The energy storage circuit 236 is electrically coupled to the first node N1, and configured to store electric energy.

The third initialization circuit 237 is electrically coupled to a first initial control end HR, a third initial voltage end 13 and the first electrode of the light-emitting element E0, and configured to write a third initial voltage Vinit3 provided by the third initial voltage end 13 into the first electrode of the light-emitting element E0 under the control of a first initial control signal provided by the first initial control end HR.

In the pixel circuit as shown in FIG. 19, the third voltage end is a low level end ELVSS.

In a possible embodiment of the present disclosure, the first control circuit includes a first control transistor, and the second control circuit includes a second control transistor. A gate electrode of the first control transistor is electrically coupled to the first gate line, a first electrode of the first control transistor is electrically coupled to the first node, and a second electrode of the first control transistor is electrically coupled to the intermediate node. A gate electrode of the second control transistor is electrically coupled to the scanning line, a first electrode of the second control transistor is electrically coupled to the intermediate node, and a second electrode of the second control transistor is electrically coupled to the third node.

In a possible embodiment of the present disclosure, the first control circuit includes a first control transistor, and a second control circuit includes a second control transistor. A gate electrode of the first control transistor is electrically coupled to the first gate line, a first electrode of the first control transistor is electrically coupled to the intermediate node, and a second electrode of the first control transistor is electrically coupled to the third node. A gate electrode of the second control transistor is electrically coupled to the scanning line, a first electrode of the second control transistor is electrically coupled to the first node, and a second electrode of the second control transistor is electrically coupled to the intermediate node.

In a possible embodiment of the present disclosure, the first initialization circuit includes a first initialization transistor, a gate electrode of the first initialization transistor is electrically coupled to the first initial control end, a first electrode of the first initialization transistor is electrically coupled to the first initial voltage end, and a second electrode of the first initialization transistor is electrically coupled to the second node.

In a possible embodiment of the present disclosure, the second initialization circuit includes a second initialization transistor, a gate electrode of the second initialization transistor is electrically coupled to the second initial control end, a first electrode of the second initialization transistor is electrically coupled to the second initial voltage end, and a second electrode of the second initialization transistor is electrically coupled to the third node.

In a possible embodiment of the present disclosure, the data write-in circuit includes a write-in transistor, the first light-emission control circuit includes a first light-emission control transistor, the second light-emission control circuit includes a second light-emission control transistor, the light-emission driving circuit includes a driving transistor, and the energy storage circuit includes a storage capacitor. A gate electrode of the write-in transistor is electrically coupled to the second gate line, a first electrode of the write-in transistor is electrically coupled to the data line, and a second electrode of the write-in transistor is electrically coupled to the second node. A gate electrode of the first light-emission control transistor is electrically coupled to the light-emission control line, a first electrode of the first light-emission control transistor is electrically coupled to the power source voltage end, and a second electrode of the first light-emission control transistor is electrically coupled to the second node. A gate electrode of the second light-emission control transistor is electrically coupled to the light-emission control line, a first electrode of the second light-emission control transistor is electrically coupled to the third node, and a second electrode of the second light-emission control transistor is electrically coupled to the first electrode of the light-emitting element. A gate electrode of the driving transistor is electrically coupled to the first node, a first electrode of the driving transistor is electrically coupled to the second node, and a second electrode of the driving transistor is electrically coupled to the third node. A first end of the storage capacitor is electrically coupled to the first node, and a second end of the storage capacitor is electrically coupled to the power source voltage end.

In a possible embodiment of the present disclosure, the third initialization circuit includes a third initialization transistor, a gate electrode of the third initialization transistor is electrically coupled to the first initial control end, a first electrode of the third initialization transistor is electrically coupled to the third initial voltage end, and a second electrode of the third initialization transistor is electrically coupled to the first electrode of the light-emitting element.

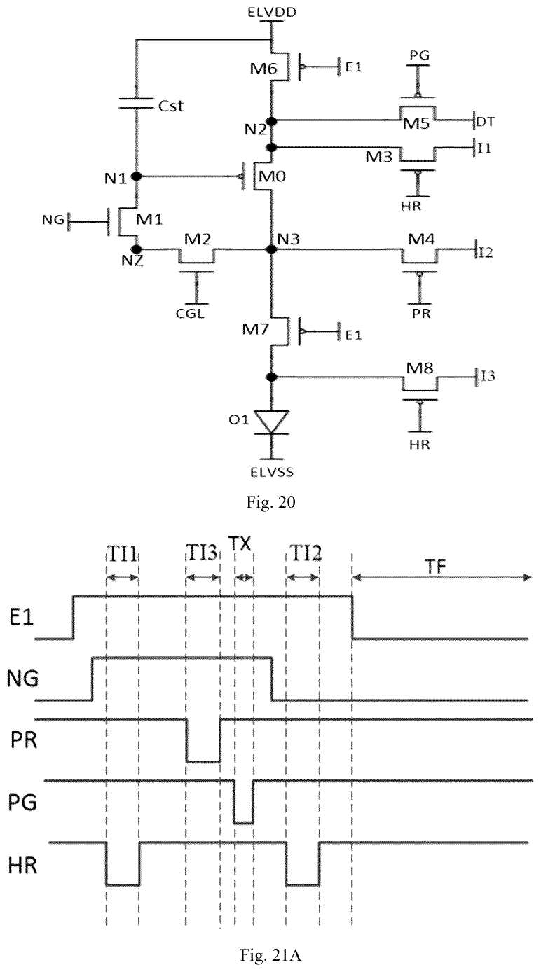

As shown in FIG. 20, based on the pixel circuit in FIG. 18, the first control circuit includes a first control transistor M1, the second control circuit includes a second control transistor M2, and the light-emission driving circuit includes a driving transistor M0. A gate electrode of the first control transistor M1 is electrically coupled to the first gate line NG, a source electrode of the first control transistor M1 is electrically coupled to a first node N1, and a second electrode of the first control transistor M1 is electrically coupled to an intermediate node NZ. A gate electrode of the second control transistor M2 is electrically coupled to the scanning line CGL, a source electrode of the second control transistor M2 is electrically coupled to the intermediate node NZ, and a drain electrode of the second control transistor M2 is electrically coupled to a third node N3. A gate electrode of the driving transistor M0 is electrically coupled to the first node N1, a source electrode of the driving transistor M0 is electrically coupled to a second node N2, and a drain electrode of the driving transistor M0 is electrically coupled to the third node N3.

The first initialization circuit includes a first initialization transistor M3, a gate electrode of the first initialization transistor M3 is electrically coupled to the first initial control end HR, a source electrode of the first initialization transistor M3 is electrically coupled to the first initial voltage end I1, and a drain electrode of the first initialization transistor M3 is electrically coupled to the second node N2. The first initial voltage end I1 is configured to provide a first initial voltage Vinit1.

The second initialization circuit includes a second initialization transistor M4, a gate electrode of the second initialization transistor M4 is electrically coupled to the second initial control end PR, a source electrode of the second initialization transistor M4 is electrically coupled to the second initial voltage end 12, and a drain electrode of the second initialization transistor M4 is electrically coupled to the third node N3. The second initial voltage end 12 is configured to provide a second initial voltage Vinit2.

The data write-in circuit includes a write-in transistor M5, the first light-emission control circuit includes a first light-emission control transistor M6, the second light-emission control circuit includes a second light-emission control transistor M7, the energy storage circuit includes a storage capacitor Cst, and the light-emitting element is an OLED O1. A gate electrode of the write-in transistor M5 is electrically coupled to the second gate line PG, a source electrode of the write-in transistor M5 is electrically coupled to the data line DT, and a drain electrode of the write-in transistor M5 is electrically coupled to the second node N2. A gate electrode of the first light-emission control transistor M6 is electrically coupled to the light-emission control line E1, a source electrode of the first light-emission control transistor M6 is electrically coupled to the power source voltage end ELVDD, and a drain electrode of the first light-emission control transistor M6 is electrically coupled to the second node N2. A gate electrode of the second light-emission control transistor M7 is electrically coupled to the light-emission control line E1, a source electrode of the second light-emission control transistor M7 is electrically coupled to the third node N3, and a drain electrode of the second light-emission control transistor M7 is electrically coupled to an anode of the OLED O1. A first end of the storage capacitor Cst is electrically coupled to the first node N1, and a second end of the storage capacitor Cst is electrically coupled to the power source voltage end ELVDD.

The third initialization circuit includes a third initialization transistor M8, a gate electrode of the third initialization transistor M8 is electrically coupled to the first initial control end HR, a source electrode of the third initialization transistor M8 is electrically coupled to the third initial voltage end I3, and a drain electrode of the third initialization transistor M8 is electrically coupled to the anode of the OLED O1. A cathode of the OLED O1 is electrically coupled to a low level end ELVSS.

In the pixel circuit as shown in FIG. 20, M1 and M2 are n-type transistors, and the other transistors are p-type transistors. However, the present disclosure is not limited thereto.

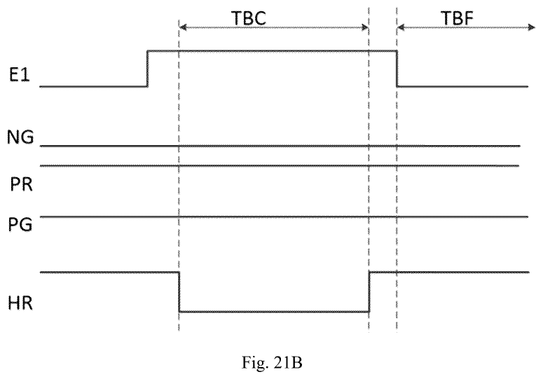

As shown in FIG. 21A, during the operation of the pixel circuit in FIG. 20, one display frame includes a first initialization time period TI1, a third initialization time period TI3, a data write-in time period TX, a second initialization time period TI2 and a light-emitting time period TF arranged one after another. Within the display frame, CG outputs a high voltage signal, so as to turn on M2.

Within the first initialization time period TI1, the third initialization time period TI3 and the data write-in time period TX, NG outputs a high voltage signal, so as to turn on M1.

Within the first initialization time period TI1, the third initialization time period TI3, the data write-in time period TX and the second initialization time period TI2, E1 provides a high voltage signal, so as to turn off M6 and M7.

Within the second initialization time period TI2 and the light-emitting time period TF, NG outputs a low voltage signal, so as to turn off M1.

Within the first initialization time period TI1, HR outputs a low voltage signal, and PR and PG both output a high voltage signal, so as to turn on M3, and write the first initial voltage Vinit1 provided by the first initial voltage end I1 into the second node N2. M0 is turned on, so as to control N2 to be electrically coupled to N3. M1 and M2 are turned on, so as to control N1 to be electrically coupled to N3. In this way, it is able to initialize a potential at the first node N1, a potential at the second node N2 and a potential at the third node N3, thereby to reduce a subsequent charging difference.

Within the third initialization time period TI3, PR outputs a low voltage signal, and HR and PG both output a high voltage signal, so as to turn on M4 and write the second initial voltage Vinit 2 provided by 12 into the third node N3, thereby to turn on M0 at the beginning of the data write-in time period TX.

Within the data write-in time period TX, HR and PR both output a high voltage signal, and PG outputs a low voltage signal, so that M5 is turned on and DT provides the data voltage Vdata to N2.

At the beginning of the data write-in time period TX, M0 is turned on, Cst is charged through Vdata until the potential at the first node N1 reaches Vdata+Vth, and then M0 is turned off, where Vth is a threshold voltage of M0.

Within the second initialization time period TI2, HR provides a low voltage signal, and PR and PG both output a high voltage signal, so as to turn on M3 and write Vinit1 into the second node N2. M0 is turned on, so that N2 is electrically coupled to N3. At this time, the potential at N1 is a small positive voltage, and the potentials at N2 and N3 are large positive voltages, so M0 is in a biased state. All the driving transistors included in the display panel are in the biased state, so it is able to improve a hysteresis phenomenon.

In at least one embodiment of the present disclosure, a voltage value of Vinit1 is a positive value, e.g., the voltage value of Vinit1 is greater than or equal to 4V and smaller than or equal to 7V. A voltage value of Vinit 2 and a voltage value of Vinit3 are negative values, e.g., each of the voltage value of Vinit2 and the voltage value of Vinit3 is greater than or equal to −5V and smaller than or equal to −3V. However, the present disclosure is not limited thereto.

During the operation of the pixel circuit in FIG. 20, within the first initialization time period, the potentials at N1, N2 and N3 are all set as a reference voltage, so that within the data write-in time period, the writing of the data voltage in a current frame is not adversely affected by the data voltage in a previous frame.

During the operation of the pixel circuit in FIG. 20, in a case that the data voltage does not need to be refreshed for the pixel circuit, CG needs to be controlled to output a low voltage signal within at least a part of the blank time period between two display frames, and CG continuously outputs a low voltage signal within a next display frame to turn off M2, so as to not write the data voltage, thereby to maintain a display image, i.e., not refresh the image. In a case that the data voltage needs to be refreshed for the pixel circuit, CG needs to be controlled to output a high voltage signal within at least a part of the blank time period between two display frames, and CG continuously outputs a high voltage signal within a next display frame to turn on M2, so as to write the data voltage within the data write-in time period, thereby to refresh the image.

As shown in FIG. 21A, in the sequence diagram, the display frame is a refresh frame.

As shown in FIG. 21B, during the operation of the pixel circuit in FIG. 20, a skip frame includes a skip initial time period TBC and a skip light-emitting time period TBF arranged one after another. Within the skip initial time period TBC, HR outputs a low voltage signal, NG outputs a low voltage signal, PR and PG both outputs a high voltage signal, and E1 provides a high voltage signal, so M1 is turned off to control N1 to be electrically decoupled from N3, M6 and M7 are turned off, and M5 is turned off. M3 and M8 are turned on, I1 provides the first initial voltage Vinit1 to the second node N2, and the driving transistor M0 is turned on, so as to control N2 to be electrically coupled to N3, initialize the potential at the second node N2 and the potential at the third node N3, thereby to improve the hysteresis phenomenon. I3 provides the third initial voltage Vinit3 to the third node N3, and the potential at the anode of O1 is initialized, so as to control O1 not to emit light, and eliminate residual electric charges on the anode of O1. Within the skip light-emitting time period TBF, E1 provides a low voltage signal, HR provides a high voltage signal, NG outputs a low voltage signal, and PR and PG both output a high voltage signal, so M1, M2, M3, M4, M5 and M8 are turned off, M6 and M7 are turned on, and M0 drives O1 to emit light.

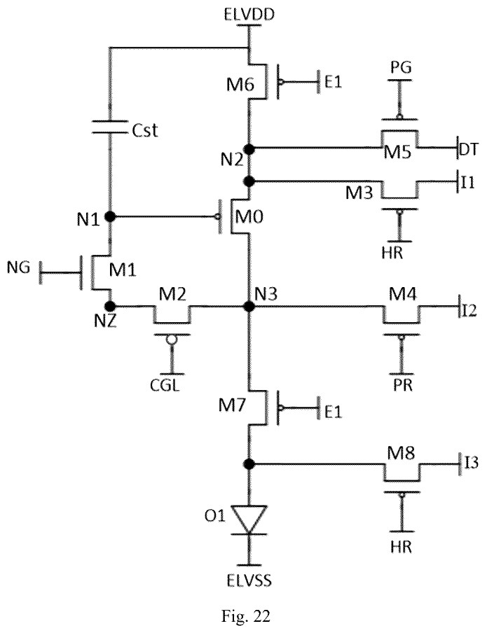

The pixel circuit in FIG. 22 differs from the pixel circuit in FIG. 20 in that M2 is a p-type transistor.

During the operation of the pixel circuit in FIG. 22, in a case that the data voltage does not need to be refreshed for the pixel circuit, CG needs to be controlled to output a high voltage signal within at least a part of the blank time period between two display frames, and CG continuously outputs a low voltage signal within a next display frame to turn off M2, so as to not write the data voltage, thereby to maintain a display image, i.e., not refresh the image. In a case that the data voltage needs to be refreshed for the pixel circuit, CG needs to be controlled to output a low voltage signal within at least a part of the blank time period between two display frames, and CG continuously outputs a high voltage signal within a next display frame to turn on M2, so as to write the data voltage within the data write-in time period, thereby to refresh the image.

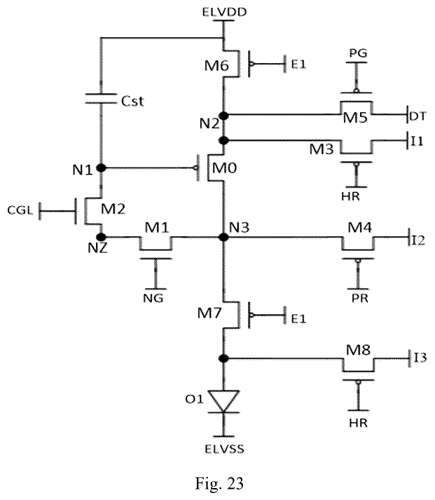

The pixel circuit in FIG. 23 differs from the pixel circuit in FIG. 20 in that: a gate electrode of the first control transistor M1 is electrically coupled to the first gate line NG, a source electrode of the first control transistor M1 is electrically coupled to the intermediate node NZ, and a drain electrode of the first control transistor M1 is electrically coupled to the third node N3; and a gate electrode of the second control transistor M2 is electrically coupled to the scanning line CGL, a source electrode of the second control transistor M2 is electrically coupled to the first node N1, and a drain electrode of the second control transistor M2 is electrically coupled to the intermediate node NZ.

In the pixel circuit as shown in FIG. 23, M1 and M2 are both n-type transistors.

During the operation of the pixel circuit in FIG. 23, in a case that the data voltage does not need to be refreshed for the pixel circuit, CG needs to be controlled to output a low voltage signal within at least a part of the blank time period between two display frames, and CG continuously outputs a low voltage signal within a next display frame to turn off M2, so as to not write the data voltage, thereby to maintain a display image, i.e., not refresh the image. In a case that the data voltage needs to be refreshed for the pixel circuit, CG needs to be controlled to output a high voltage signal within at least a part of the blank time period between two display frames, and CG continuously outputs a high voltage signal within a next display frame to turn on M2, so as to write the data voltage within the data write-in time period, thereby to refresh the image.

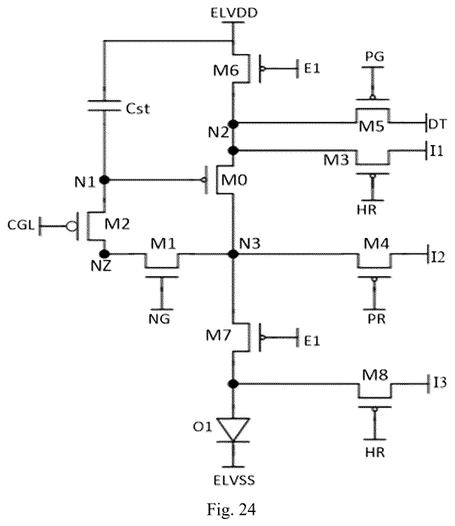

The pixel circuit in FIG. 24 differs from the pixel circuit in FIG. 23 in that M2 is a p-type transistor.

During the operation of the pixel circuit in FIG. 24, in a case that the data voltage does not need to be refreshed for the pixel circuit, CG needs to be controlled to output a high voltage signal within at least a part of the blank time period between two display frames, and CG continuously outputs a low voltage signal within a next display frame to turn off M2, so as to not write the data voltage, thereby to maintain a display image, i.e., not refresh the image. In a case that the data voltage needs to be refreshed for the pixel circuit, CG needs to be controlled to output a low voltage signal within at least a part of the blank time period between two display frames, and CG continuously outputs a high voltage signal within a next display frame to turn on M2, so as to write the data voltage within the data write-in time period, thereby to refresh the image.

The present disclosure further provides in some embodiments a pixel driving method for the above-mentioned pixel circuit, which includes: generating, by a light-emission driving circuit, a driving current for driving a light-emitting element under the control of a potential at a first node; and controlling, by a control circuit, the first node to be electrically coupled to, or electrically decoupled from, a first electrode of a light-emitting element under the control of a first gate driving signal and a scanning signal.

In at least one embodiment of the present disclosure, the pixel circuit includes a first initialization circuit, a first end of the light-emission driving circuit is electrically coupled to a second node, a second end of the light-emission driving circuit is electrically coupled to a third node and the first electrode of the light-emitting element, and a display period includes a first initialization time period and a second initialization time period arranged one after another. The pixel driving method includes: within the first initialization time period, controlling, by the control circuit, the first node to be electrically coupled to the third node under the control of the first gate driving signal and the scanning signal, writing, by the first initialization circuit, a first initial voltage into the second node under the control of a first initial control signal, and controlling, by the light-emission driving circuit, the second node to be electrically coupled to the third node under the control of a potential at the first node; and within a second initialization time period, controlling, by the control circuit, the first node to be electrically decoupled from the third node under the control of the first gate driving signal and the scanning signal, writing, by the first initialization circuit, the first initial voltage into the second node under the control of the first initial control signal, and controlling, by the light-emission driving circuit, the second node to be electrically coupled to the third node under the control of the potential at the first node.

The present disclosure further provides in some embodiments a display panel, which includes a source driver and the above-mentioned driving circuit. The source driver includes a data output end.

In at least one embodiment of the present disclosure, the display panel includes a plurality of scanning lines, and a scanning signal output end in a scanning signal generation circuit of the driving circuit is electrically coupled to the scanning line.

During the implementation, the display panel includes the plurality of scanning lines, and the scanning signal output end is electrically coupled to the scanning line, so as to provide a scanning signal to the scanning line.

In a possible embodiment of the present disclosure, the display panel includes a plurality of data lines; the data output end is directly electrically coupled to the data line; or the driving circuit includes a second switching circuit, and the second switching circuit is configured to control the data output end to be electrically coupled to, or electrically decoupled from, the data line under the control of a second gating control signal.

In at least one embodiment of the present disclosure, the source driver is arranged at a first side of the display panel, and the driving circuit is arranged at the first side of the display panel; or the source driver is arranged at the first side of the display panel, the driving circuit is arranged at a second side of the display panel, and the first side is opposite to the second side.

For example, the first side is a lower side, and the second side is an upper side. However, the present disclosure is not limited thereto.

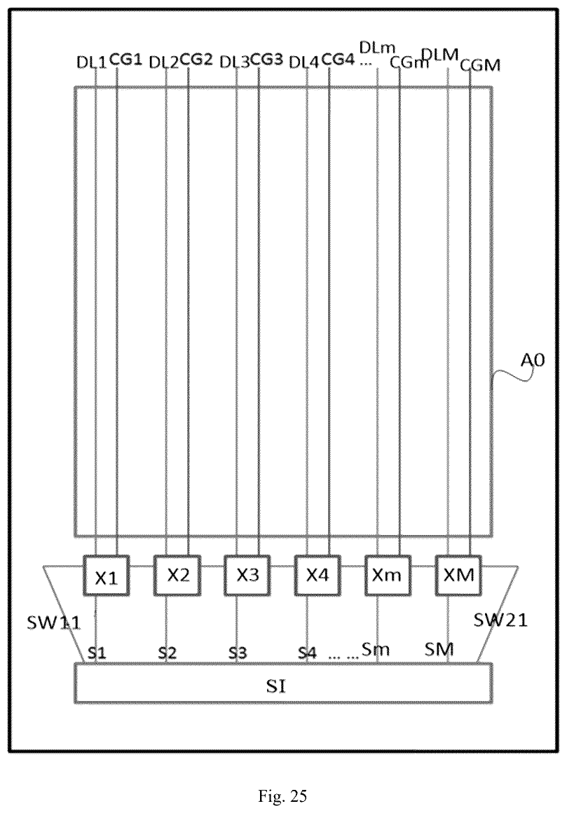

As shown in FIG. 25, A0 represents a display region of the display panel, DL1 represents a first data line, CG1 represents a first scanning line, DL2 represents a second data line, CG2 represents a second scanning line, DL3 represents a third data line, CG3 represents a third scanning line, DLA represents a fourth data line, CG4 represents a fourth scanning line, DLm represents an m^{th} data line, CGm represents an m^{th} scanning line, DLM represents an M^{th} data line, and CGM represents an M^{th} scanning line, where m and M are positive integers. SI represents the source driver, S1 represents a first data output end of the source driver SI, S2 represents a second data output end of the source driver SI, S3 represents a third data output end of the source driver SI, S4 represents a fourth data output end of the source driver SI, Sm represents an m^{th} data output end, SM represents an M^{th} data output end, SW11 represents a first one of the first gating control lines, and SW21 represents a second one of the first gating control lines. The source driver SI is electrically coupled to SW11 and SW21, and configured to provide a first one of first gating control signals to SW11, and provide a second one of first gating control signals to SW21.

In FIG. 25, X1 represents a first gating unit, X2 represents a second gating unit, X3 represents a third gating unit, X4 represents a fourth gating unit, Xm represents an m^{th} gating unit, and XM represents an M^{th} gating unit. Each gating unit includes a first switching circuit and a scanning signal generation circuit, or each gating unit includes a first switching circuit, a second switching circuit and a scanning signal generation circuit.

As shown in FIG. 25, the first gating unit X1 is electrically coupled to DL1 and CG1, the second gating unit X2 is electrically coupled to DL2 and CG2, the third gating unit X3 is electrically coupled to DL3 and CG3, the fourth gating unit X4 is electrically coupled to DL4 and CG4, the m^{th} gating unit Xm is electrically coupled to DLm and CGm, and the M^{th} gating unit XM is electrically coupled to DLM and CGM. The source driver SI is arranged below A0, and the first gating unit X1, the second gating unit X2, the third gating unit X3, the fourth gating unit X4, the m^{th} gating unit Xm and the M^{th} gating unit XM are arranged below A0.

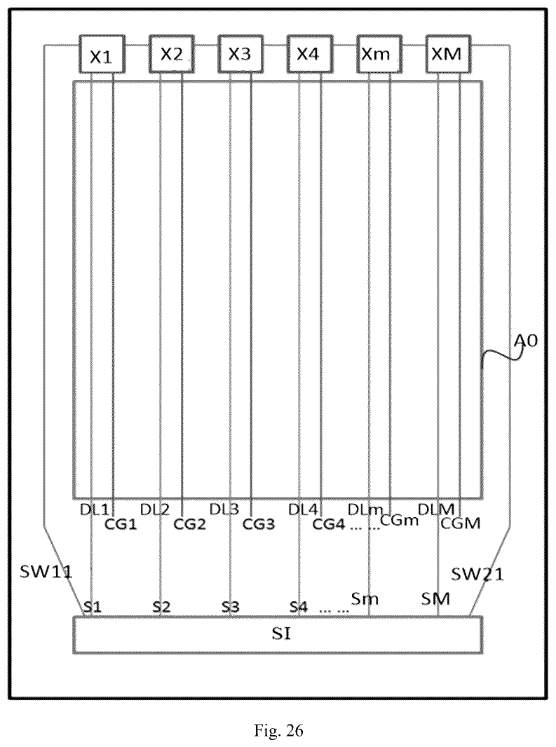

The display panel in FIG. 26 differs from the display panel in FIG. 25 in that the first gating unit X1, the second gating unit X2, the third gating unit X3, the fourth gating unit X4, the m^{th} gating unit Xm and the M^{th} gating unit XM are arranged above A0.

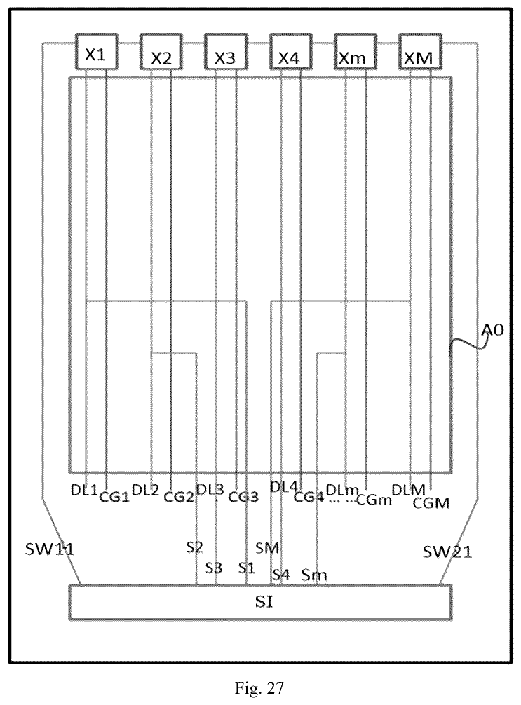

The display panel in FIG. 27 differs from the display panel in FIG. 26 in that the data output ends of the source driver SI are located in the middle of the display panel, so as to achieve a lower narrow bezel. The display panel in FIG. 27 is combined with a Fanout In Pixel (FIP) embodiment. The display panel further includes the above-mentioned pixel circuits arranged in a plurality of rows and columns.

In the display panel as shown in FIGS. 25 to 27, each gating unit may be the driving circuit mentioned in the above embodiments of the present disclosure.

In at least one embodiment of the present disclosure, two columns of pixel circuits may be electrically coupled to a same scanning line.

The present disclosure provides in some embodiments a driving scheme for an OLED display device. Through locally refreshing the pixel circuit in combination with a source driving circuit and a driving scheme thereof, an image on a screen is locally updated by means of an HCT control signal (the HCT control signal may be a data signal provided by the source driver through the data output end within the blank time period), without any necessity to perform charging and discharging for the other images multiple times. As a result, it is able to further reduce the power consumption of the OLED display device, or locally update the display image to achieve ultra-low power consumption.

In at least one embodiment of the present disclosure, for a display device, in a case that a part of an image needs to be updated, e.g., in a case that merely date and time need to be updated, whether or not a gate driving circuit outputs a signal is controlled in a row direction. In a row where the image needs to be updated, a first gate driving signal is outputted normally, so as to normally turn on a first control transistor in a pixel circuit in a display region, thereby to update the data. In a row where the image does not need to be updated, a potential of the first gate driving signal is maintained all the time, so as to turn off the first control transistor, and ensure that the pixel brightness remains unchanged, thereby to locally refresh the image in the row direction. In a column direction, whether or not to locally refresh the image is achieved through controlling whether or not to turn on the second control transistor in the pixel circuit through the scanning line. Within the blank time period between two display frames, the source driver outputs an HCT pulse to write different scanning signals into the scanning line. In a case that an image in a current column needs to be updated, the scanning line needs to ensure that the second control transistor is turned on all the time so as to refresh the image in the current column normally. In a case that an image in some columns does not need to be updated, the scanning line needs to ensure that the second control transistors in the pixel circuits in these columns are turned off all the time.

In at least one embodiment of the present disclosure, the display panel further includes the above-mentioned pixel circuit.

The present disclosure further provides in some embodiments a display device which includes the above-mentioned display panel.

The above are the preferred embodiments of the present disclosure. It should be appreciated that, improvements and modifications may be made by a person skilled in the art without departing from the principle of the p resent disclosure, and these improvements and modifications shall also fall within the scope of the present disclosure.

1. A driving circuit, comprising a first switching circuit and a scanning signal generation circuit,
wherein the first switching circuit is electrically coupled to a first gating control line, a data output end of a source driver and the scanning signal generation circuit, and configured to control to write a data signal provided by the data output end into the scanning signal generation circuit under the control of a first gating control signal provided by the first gating control line; and
the scanning signal generation circuit is configured to generate a scanning signal in accordance with the data signal, and output the scanning signal through a scanning signal output end.

2. The driving circuit according to claim 1, further comprising a second switching circuit,
wherein the second switching circuit is electrically coupled to a second gating control line, the data output end and a data line comprised in a display panel, and configured to control the data output end to be electrically coupled to, or electrically decoupled from, the data line under the control of a second gating control signal provided by the second gating control line; and
the first gating control line and the second gating control line are a same gating control line, or the first gating control line is different from the second gating control line.

3. The driving circuit according to claim 1, wherein the first switching circuit comprises a first transistor and a first capacitor, and the first switching circuit provides the data signal to the scanning signal generation circuit through a control node;
a gate electrode of the first transistor is electrically coupled to the first gating control line, a first electrode of the first transistor is electrically coupled to the data output end, and a second electrode of the first transistor is electrically coupled to the control node; and
a first end of the first capacitor is electrically coupled to the control node, and a second end of the first capacitor is electrically coupled to a direct-current voltage end.

4. The driving circuit according to claim 2, wherein the second switching circuit comprises a second transistor, a gate electrode of the second transistor is electrically coupled to the second gating control line, a first electrode of the second transistor is electrically coupled to the data output end, and a second electrode of the second transistor is electrically coupled to the data line.

5. The driving circuit according to claim 1, wherein the scanning signal generation circuit comprises an output control circuit and an output circuit, and the first switching circuit provides the data signal to the scanning signal generation circuit through a control node;
the output control circuit is electrically coupled to the control node, a first voltage end, a second voltage end, an output control end and a scanning output end, and configured to control the output control end to be electrically coupled to, or electrically decoupled from, the first voltage end under the control of a potential at the control node, and control the output control end to be electrically coupled to, or electrically decoupled from, the second voltage end under the control of a signal provided by the scanning output end; and
the output circuit is electrically coupled to a control end, the scanning output end, the output control end, the first voltage end and the second voltage end, and configured to control the scanning output end to be electrically coupled to, or electrically decoupled from, the first voltage end under the control of a control signal provided by the control end, and control the scanning output end to be electrically coupled to, or electrically decoupled from, the second voltage end under the control of a potential at the output control end,
wherein the scanning output end is the scanning signal output end; or
the scanning signal generation circuit further comprises a phase inverting circuit, an input end of the phase inverting circuit is electrically coupled to the scanning output end, an output end of the phase inverting circuit is electrically coupled to the scanning signal output end, and the phase inverting circuit is configured to invert a phase of a voltage signal received by the input end of the phase inverting circuit to obtain a phase-inverted voltage signal, and output the phase-inverted voltage signal through the output end of the phase inverting circuit, and/or
wherein the output control circuit comprises a third transistor and a fourth transistor;
a gate electrode of the third transistor is electrically coupled to the control node, a first electrode of the third transistor is electrically coupled to the first voltage end, and a second electrode of the third transistor is electrically coupled to the output control end;
a gate electrode of the fourth transistor is electrically coupled to the scanning output end, a first electrode of the fourth transistor is electrically coupled to the output control end, and a second electrode of the fourth transistor is electrically coupled to the second voltage end;
the output circuit comprises a fifth transistor, a sixth transistor and a second capacitor;
a gate electrode of the fifth transistor is electrically coupled to the control end, a first electrode of the fifth transistor is electrically coupled to the first voltage end, and a second electrode of the fifth transistor is electrically coupled to the scanning output end;
a gate electrode of the sixth transistor is electrically coupled to the output control end, a first electrode of the sixth transistor is electrically coupled to the scanning output end, and a second electrode of the sixth transistor is electrically coupled to the second voltage end; and
a first end of the second capacitor is electrically coupled to the control end, and a second end of the second capacitor is electrically coupled to the second voltage end.

6. (canceled)

7. (canceled)

8. A driving method, for the driving circuit according to claim 1, comprising, within at least a part of a blank time period between two display frames:
controlling, by a first switching circuit, to write a data signal provided by a data output end of a source driver into a scanning signal generation circuit under the control of a first gating control signal; and
generating, by the scanning signal generation circuit, a scanning signal in accordance with the data signal, and outputting the scanning signal to a corresponding scanning line in a display panel through a scanning signal output end,
wherein the driving circuit further comprises a second switching circuit, and the driving method further comprises, within a data write-in time period in one display frame, controlling, by the second switching circuit, the data output end of the source driver to be electrically coupled to a corresponding data line in the display panel under the control of a second gating control signal.

9. (canceled)

10. A pixel circuit, comprising a light-emitting element, a light-emission driving circuit and a control circuit,
wherein the light-emission driving circuit is electrically coupled to a first node and a first electrode of the light-emitting element and configured to generate a driving current for driving the light-emitting element under the control of a potential at the first node, and a second electrode of the light-emitting element is electrically coupled to a third voltage end; and
the control circuit is electrically coupled to a first gate line, a scanning line, the first node and the first electrode of the light-emitting element, and configured to control the first node to be electrically coupled to, or electrically decoupled from, the first electrode of the light-emitting element under the control of a first gate driving signal provided by the first gate line and a scanning signal provided by the scanning line.

11. The pixel circuit according to claim 10, wherein the control circuit comprises a first control circuit and a second control circuit, a first end of the light-emission driving circuit is electrically coupled to a second node, and a second end of the light-emission driving circuit is electrically coupled to a third node and the first electrode of the light-emitting element;
the first control circuit is electrically coupled to the first gate line, the first node and an intermediate node, and configured to control the first node to be electrically coupled to, or electrically decoupled from, the intermediate node under the control of the first gate driving signal provided by the first gate line; and
the second control circuit is electrically coupled to the scanning line, the intermediate node and the third node, and configured to control the intermediate node to be electrically coupled to, or electrically decoupled from, the third node under the control of the scanning signal provided by the scanning line.

12. The pixel circuit according to claim 10, wherein the control circuit comprises a first control circuit and a second control circuit, a first end of the light-emission driving circuit is electrically coupled to a second node, and a second end of the light-emission driving circuit is electrically coupled to a third node and the first electrode of the light-emitting element;
the first control circuit is electrically coupled to the first gate line, the third node and an intermediate node, and configured to control the third node to be electrically coupled to, or electrically decoupled from, the intermediate node under the control of the first gate driving signal provided by the first gate line; and
the second control circuit is electrically coupled to the scanning line, the intermediate node and the first node, and configured to control the intermediate node to be electrically coupled to, or electrically decoupled from, the first node under the control of the scanning signal provided by the scanning line.

13. The pixel circuit according to claim 10, further comprising a first initialization circuit, wherein a first end of the light-emission driving circuit is electrically coupled to a second node, and a second end of the light-emission driving circuit is electrically coupled to a third node and the first electrode of the light-emitting element; and
the first initialization circuit is electrically coupled to a first initial control end, a first initial voltage end and the second node, and configured to write a first initial voltage provided by the first initial voltage end into the second node under the control of a first initial control signal provided by the first initial control end.

14. The pixel circuit according to claim 10, further comprising a second initialization circuit, wherein a first end of the light-emission driving circuit is electrically coupled to a second node, and a second end of the light-emission driving circuit is electrically coupled to a third node and the first electrode of the light-emitting element; and
the second initialization circuit is electrically coupled to a second initial control end, a second initial voltage end and the third node, and configured to write a second initial voltage provided by the second initial voltage end into the third node under the control of a second initial control signal provided by the second initial control end.

15. The pixel circuit according to claim 10, further comprising a data write-in circuit, a first light-emission control circuit, a second light-emission control circuit and an energy storage circuit, wherein a first end of the light-emission driving circuit is electrically coupled to a second node, and a second end of the light-emission driving circuit is electrically coupled to a third node and the first electrode of the light-emitting element;
the data write-in circuit is electrically coupled to a second gate line, a data line and the second node, and configured to write a data voltage provided by the data line into the second node under the control of a second gate driving signal provided by the second gate line;
the first light-emission control circuit is electrically coupled to a light-emission control line, a power source voltage end and the second node, and configured to control the power source voltage end to be electrically coupled to, or electrically decoupled from, the second node under the control of a light-emission control signal provided by the light-emission control line;
the second light-emission control circuit is electrically coupled to the light-emission control line, the third node and the first electrode of the light-emitting element, and configured to control the third node to be electrically coupled to the first electrode of the light-emitting element under the control of the light-emission control signal; and
the energy storage circuit is electrically coupled to the first node, and configured to store electric energy,
wherein the pixel circuit further comprises a third initialization circuit, wherein the third initialization circuit is electrically coupled to a first initial control end, a third initial control end and the first electrode of the light-emitting element, and configured to write a third initial voltage provided by the third initial voltage end into the first electrode of the light-emitting element under the control of a first initial control signal provided by the first initial control end.

16. (canceled)

17. The pixel circuit according to claim 11, wherein the first control circuit comprises a first control transistor, and the second control circuit comprises a second control transistor;
a gate electrode of the first control transistor is electrically coupled to the first gate line, a first electrode of the first control transistor is electrically coupled to the first node, and a second electrode of the first control transistor is electrically coupled to the intermediate node; and
a gate electrode of the second control transistor is electrically coupled to the scanning line, a first electrode of the second control transistor is electrically coupled to the intermediate node, and a second electrode of the second control transistor is electrically coupled to the third node.

18. The pixel circuit according to claim 12, wherein the first control circuit comprises a first control transistor, and a second control circuit comprises a second control transistor;
a gate electrode of the first control transistor is electrically coupled to the first gate line, a first electrode of the first control transistor is electrically coupled to the intermediate node, and a second electrode of the first control transistor is electrically coupled to the third node; and
a gate electrode of the second control transistor is electrically coupled to the scanning line, a first electrode of the second control transistor is electrically coupled to the first node, and a second electrode of the second control transistor is electrically coupled to the intermediate node.

19. The pixel circuit according to claim 13, wherein the first initialization circuit comprises a first initialization transistor, a gate electrode of the first initialization transistor is electrically coupled to the first initial control end, a first electrode of the first initialization transistor is electrically coupled to the first initial voltage end, and a second electrode of the first initialization transistor is electrically coupled to the second node.

20. The pixel circuit according to claim 14, wherein the second initialization circuit comprises a second initialization transistor, a gate electrode of the second initialization transistor is electrically coupled to the second initial control end, a first electrode of the second initialization transistor is electrically coupled to the second initial voltage end, and a second electrode of the second initialization transistor is electrically coupled to the third node.

21. The pixel circuit according to claim 15, wherein the data write-in circuit comprises a write-in transistor, the first light-emission control circuit comprises a first light-emission control transistor, the second light-emission control circuit comprises a second light-emission control transistor, the light-emission driving circuit comprises a driving transistor, and the energy storage circuit comprises a storage capacitor;
a gate electrode of the write-in transistor is electrically coupled to the second gate line, a first electrode of the write-in transistor is electrically coupled to the data line, and a second electrode of the write-in transistor is electrically coupled to the second node;
a gate electrode of the first light-emission control transistor is electrically coupled to the light-emission control line, a first electrode of the first light-emission control transistor is electrically coupled to the power source voltage end, and a second electrode of the first light-emission control transistor is electrically coupled to the second node;
a gate electrode of the second light-emission control transistor is electrically coupled to the light-emission control line, a first electrode of the second light-emission control transistor is electrically coupled to the third node, and a second electrode of the second light-emission control transistor is electrically coupled to the first electrode of the light-emitting element;
a gate electrode of the driving transistor is electrically coupled to the first node, a first electrode of the driving transistor is electrically coupled to the second node, and a second electrode of the driving transistor is electrically coupled to the third node; and
a first end of the storage capacitor is electrically coupled to the first node, and a second end of the storage capacitor is electrically coupled to the power source voltage end,
wherein the third initialization circuit comprises a third initialization transistor, a gate electrode of the third initialization transistor is electrically coupled to the first initial control end, a first electrode of the third initialization transistor is electrically coupled to the third initial voltage end, and a second electrode of the third initialization transistor is electrically coupled to the first electrode of the light-emitting element.

22. (canceled)

23. A pixel driving method, for a pixel circuit according to claim 10, comprising:
generating, by a light-emission driving circuit, a driving current for driving a light-emitting element under the control of a potential at a first node; and
controlling, by a control circuit, the first node to be electrically coupled to, or electrically decoupled from, a first electrode of a light-emitting element under the control of a first gate driving signal and a scanning signal,
wherein the pixel circuit comprises a first initialization circuit, a first end of the light-emission driving circuit is electrically coupled to a second node, a second end of the light-emission driving circuit is electrically coupled to a third node and the first electrode of the light-emitting element, and a display period comprises a first initialization time period and a second initialization time period arranged one after another, wherein the pixel driving method comprises:
within the first initialization time period, controlling, by the control circuit, the first node to be electrically coupled to the third node under the control of the first gate driving signal and the scanning signal, writing, by the first initialization circuit, a first initial voltage into the second node under the control of a first initial control signal, and controlling, by the light-emission driving circuit, the second node to be electrically coupled to the third node under the control of a potential at the first node; and
within a second initialization time period, controlling, by the control circuit, the first node to be electrically decoupled from the third node under the control of the first gate driving signal and the scanning signal, writing, by the first initialization circuit, the first initial voltage into the second node under the control of the first initial control signal, and controlling, by the light-emission driving circuit, the second node to be electrically coupled to the third node under the control of the potential at the first node.

24. (canceled)

25. A display panel, comprising a source driver and the driving circuit according to claim 1, wherein the source driver comprises a data output end,
wherein the display panel further comprises a plurality of scanning lines, wherein a scanning signal output end in a scanning signal generation circuit of the driving circuit is electrically coupled to the scanning line; and/or
wherein the display panel further comprises a plurality of data lines, wherein the data output end is directly electrically coupled to the data line; or the driving circuit comprises a second switching circuit, and the second switching circuit is configured to control the data output end to be electrically coupled to, or electrically decoupled from, the data line under the control of a second gating control signal,
wherein the source driver is arranged at a first side of the display panel, and the driving circuit is arranged at the first side of the display panel; or
the source driver is arranged at the first side of the display panel, the driving circuit is arranged at a second side of the display panel, and the first side is opposite to the second side,
wherein the display panel further comprises the pixel circuit according to claim 10.

26. (canceled)

27. (canceled)

28. (canceled)

29. (canceled)

30. A display device, comprising the display panel according to claim 25.
